(19) United States
(12) Patent Application Publication
(10) Pub. No.: US 2012/0239400 A1
(43) Pub. Date: Sep. 20, 2012

(54) SPEECH DATA ANALYSIS DEVICE, SPEECH DATA ANALYSIS METHOD AND SPEECH DATA ANALYSIS PROGRAM

(75) Inventor: Takafumi Koshinaka, Minato-ku (JP)

(73) Assignee: NRC Corporation, Minato-ku ,Tokyo (JP)

(21) Appl. No.: 13/511,889

(22) PCT Filed: Oct. 21, 2010
(86) PCT No.: PCT/JP2010/006239

§ 371 Date: May 24, 2012

(30) Foreign Application Priority Data
Nov. 25, 2009 (JP) 2009-267770

(51) Int. Cl. G10L 17/00

(52) U.S. Cl. 704/249; 704/E17.004

(57) ABSTRACT

A speaker or a set of speakers can be recognized with high accuracy even when multiple speakers and a relationship between speakers change over time. A device comprises a speaker model derivation means for deriving a speaker model for defining a voice property per speaker from speech data made of multiple utterances to which speaker labels as information for identifying a speaker are given, a speaker co-occurrence model derivation means for, by use of the speaker model derived by the speaker model derivation means, deriving a speaker co-occurrence model indicating a strength of a co-occurrence relationship between the speakers from session data which is divided speech data in units of a series of conversation, and a model structure update means for, with reference to a session of newly-added speech data, detecting predefined events, and when the predefined event is detected, updating a structure of at least one of the speaker model and the speaker co-occurrence model.

### TECHNICAL FIELD

The present invention relates to a speech data analysis device, a speech data analysis method and a speech data analysis program, and particularly to a speech data analysis device, a speech data analysis method and a speech data analysis program used to learn or recognize a speaker based on speech data originated from multiple speakers.

### BACKGROUND ART

An exemplary speech data analysis device is described in Non-Patent Literature 1. The speech data analysis device described in Non-Patent Literature 1 uses speech data and a speaker label per speaker, which are previously stored, to learn a speaker model defining a voice property per speaker.

For example, a speaker model is learned for each of speaker A (speech data X₁, X₄, . . . ), speaker B (speech data X₂, . . . ), speaker C (speech data X₃, . . . ), speaker D (speech data X₅, . . . ), and others.

Then, there is performed a matching processing in which unknown speech data X independently obtained from the stored speech data is received and a similarity between an individual learned speaker model and the speech data X is calculated based on definitional equations defined by “a probability that the speaker model generates the speech data X.” Herein, a speaker ID (an identifier for identifying a speaker, which corresponds to A, B, C, D, . . . described above) corresponding to a model having a higher similarity or exceeding a predetermined threshold is output. Alternatively, a speaker matching means 205 performs a matching processing of receiving a pair of unknown speech data X and speaker ID (designated speaker ID) and calculating a similarity between the designated speaker ID's model and the speech data X. Then, there is output a determination result as to whether the similarity exceeds the predetermined threshold or whether the speech data X is of the designated speaker ID.

Further, for example, Patent Literature 1 describes therein a speaker characteristic extraction device for generating a mixed Gaussian distribution type acoustic model by way of learning per set of speakers belonging to each cluster which is clustered based on a vocal tract length expansion/contraction coefficient for a standard speaker, and calculating a likelihood of an acoustic sample of a learned speaker for each generated acoustic model, thereby to extract one acoustic model as an input speaker's characteristic.

### CITATION LIST

### Patent Literature

PLT1: Japanese Patent Application Laid-Open No. 2003-22088 Publication

### Non-Patent Literature

NPL1: Douglas A, Reynolds et al, “Speaker Verification Using Adapted Gaussian Mixture Models,” Digital signal Processing, Vol. 10, 2000, p. 19-41

### SUMMARY OF INVENTION

### Technical Problem

The technical problem described in Non-Patent Literature 1 and Patent Literature 1 is that when speakers have any relationship, the relationship cannot be effectively used, which causes a reduction in recognition accuracy.

For example, with the method described in Non-Patent Literature 1, speech data and a speaker label independently prepared for each speaker are used to independently learn a speaker model per speaker. A matching processing is independently performed for the speaker model and the input speech data X. For the method, a relationship between a speaker and another speaker is not considered at all.

For example, with the method described in Patent Literature 1, a vocal tract length expansion/contraction coefficient of a standard speaker is found for each learned speaker to cluster the learned speakers. For the method, a relationship between a speaker and another speaker is not considered at all as in Non-Patent Literature 1.

A representative application of such a speech data analysis device may be entry/exit management (voice authentication) of a security room storing confidential information therein. Such an application is not so problematic. This is because entry/exit of the security room is by one person in principle and a relationship with others is not present basically.

However, there are applications for which the assumption is not possible. For example, in the case of criminal investigation, speech data spoken via the phone by a kidnapper for ransom request is collected and is used for subsequent criminal investigations. In such a case, a lone criminal and a group of criminals may be possible. A typical group of criminals is of bank transfer scam. In recent years, crimes called “theater company type bank transfer scam” increase, and damages occurs in which persons who pretend to be a relative of a victim, persons who pretend to be a policeman or lawyer, persons who pretend to be in charge of a traffic accident or molestation case, and others sequentially speak on the phone to artfully deceive the victim.

An issue on terrorism has been increasingly problematic, and there is assumed an application in which communication between terrorists on the phone or radio communication device is captured for criminal investigations of terrorists and the obtained speech data is analyzed. In even such a scene, it can be assumed that relevant persons of an organization frequently communicate with each other in activities as a terror organization. That is, there is a trend in which several speakers in a mutual relationship tend to appear in one item of speech data.

The second issue is that even when a relationship between speakers is clear, the relationship involves a temporal change or changes over time and thus an accuracy can be lowered over time. This is because even when a wrong relationship, which is different from the actual one, is used to make recognition, an erroneous recognition result is caused of course. By way of example of the bank transfer scam or terrorists, it is assumed that a group of criminals changes over months or over years. That is, when a strength in relationship between speakers changes due to an increase/decrease in members, an increase/decrease, split-up or merger in groups, the speakers are likely to be erroneously recognized based on the relationship.

The third issue is that there is no means for recognizing a relationship itself between speakers. This is because the relationship between the speakers needs to be obtained in some way for specifying a set of speakers having a strong relationship such as a group of criminals. For example, in the criminal investigations of bank transfer scam or terrorists as described above, it is assumed that it is important to specify not only a criminal but also to specify a group of criminals.

It is therefore an object of the present invention to provide a speech data analysis device, a speech data analysis method and a speech data analysis program capable of recognizing a plurality of speakers with high accuracy. Further, it is an object of the present invention to provide a speech data analysis device, a speech data analysis method and a speech data analysis program capable of recognizing speakers with high accuracy even when a relationship between the speakers changes over time. Furthermore, it is an object to provide a speech data analysis device, a speech data analysis method and a speech data analysis program capable of recognizing a relationship itself between speakers such as a collection of speakers having a strong relationship.

### Solution to Problem

A speech data analysis device according to the present invention includes: a speaker model derivation means for deriving a speaker model defining a voice property per speaker from speech data made of multiple utterances; a speaker co-occurrence model derivation means for, by use of the speaker model derived by the speaker model derivation means, deriving a speaker co-occurrence model indicating a strength of a co-occurrence relationship between the speakers from session data which is divided speech data in units of a series of conversation; and a model structure update means for, with reference to a session of newly-added speech data, detecting predefined events in which a speaker or a cluster as a collection of speakers changes in the speaker model or the speaker co-occurrence model, and when the event is detected, updating a structure of at least one of the speaker model and the speaker co-occurrence model.

A speech data analysis device may include: a speaker model storage means for storing a speaker model defining a voice property per speaker which is derived from speech data made of multiple utterances; a speaker co-occurrence model storage means for storing a speaker co-occurrence model indicating a strength of a co-occurrence relationship between the speakers which is derived from session data which is divided speech data in units of a series of conversation; and a speakers' collection recognition means for, by use of the speaker model and the speaker co-occurrence model, calculating a consistency with the speaker model and a consistency with a co-occurrence relationship in entire speech data for each utterance contained in the designated speech data, and recognizing which cluster the designated speech data corresponds to.

A speech data analysis method according to the present invention includes: deriving a speaker model defining a voice property per speaker from speech data made of multiple utterances; deriving a speaker co-occurrence model indicating a strength of a co-occurrence relationship between the speakers from session data which is divided speech data in units of a series of conversation by use of the derived speaker model; and with reference to a session of newly-added speech data, detecting predefined events in which a speaker or a cluster as a collection of speakers changes in the speaker model or the speaker co-occurrence model, and when the event is detected, updating a structure of at least one of the speaker model and the speaker co-occurrence model.

A speech data analysis method may include: by use of a speaker model defining a voice property per speaker which is derived from speech data made of multiple utterances and a speaker co-occurrence model indicating a strength of a co-occurrence relationship between the speakers which is derived from session data which is divided speech data in units of a series of conversation, calculating a consistency with the speaker model and a consistency of a co-occurrence relationship in entire speech data for each utterance contained in the designated speech data, and recognizing which cluster the designated speech data corresponds to.

A speech data analysis program according to the present invention causes a computer to execute: a processing of deriving a speaker model defining a voice property per speaker from speech data made of multiple utterances; a processing of, by use of the derived speaker model, deriving a speaker co-occurrence model indicating a strength of a co-occurrence relationship between the speakers from session data which is divided speech data in units of a series of conversation; and a processing of, with reference to a session of newly-added speech data, detecting predefined events in which a speaker or a cluster as a collection of speakers changes in the speaker model or the speaker co-occurrence model, and when the event is detected, updating a structure of at least one of the speaker model or the speaker co-occurrence model.

A speech data analysis program may cause a computer to execute: a processing of, by use of a speaker model defining a voice property per speaker which is derived from speech data made of multiple utterances and a speaker co-occurrence model indicating a strength of a co-occurrence relationship between the speakers which is derived from session data which is divided speech data in units of a series of conversation, calculating a consistency with the speaker model and a consistency of a co-occurrence relationship in entire speech data for each utterance contained in the designated speech data, and recognizing which cluster the designated speech data corresponds to.

### ADVANTAGEOUS EFFECTS OF INVENTION

According to the present invention, a speaker can be recognized in consideration of a relationship between speakers with the above structure, and thus it is possible to provide a speech data analysis device, a speech data analysis method and a speech data analysis program capable of recognizing a plurality of speakers with high accuracy.

### BRIEF DESCRIPTION OF DRAWINGS

FIG. 1 is a block diagram showing an exemplary structure of a speech data analysis device according to a first embodiment.

FIG. 2 is an explanatory diagram showing exemplary information stored in a session speech data storage means 100 and a session speaker label storage means 101.

FIG. 3 is a state transition diagram schematically showing a speaker model.

FIG. 4 is a state transition diagram schematically showing a basic unit of a speaker co-occurrence model.

FIG. 5 is a state transition diagram schematically showing a speaker co-occurrence model.

FIG. 6 is a flowchart showing exemplary operations of a learning means 11 according to the first embodiment.

FIG. 7 is a flowchart showing exemplary operations of a recognition means 12 according to the first embodiment.

FIG. 8 is a block diagram showing an exemplary structure of a speech data analysis device according to a second embodiment.

FIG. 9 is a flowchart showing exemplary operations of a learning means 31 according to the second embodiment.

FIG. 10 is a block diagram showing an exemplary structure of a speech data analysis device according to a third embodiment.

FIG. 11 is a block diagram showing an exemplary structure of a speech data analysis device according to a fourth embodiment.

FIG. 12 is a block diagram showing an exemplary structure of a speech data analysis device (a model generation device) according to a fifth embodiment.

FIG. 13 is a block diagram showing an exemplary structure of a speech data analysis device (a speaker/set of speakers recognition device) according to a sixth embodiment.

FIG. 14 is a block diagram showing an outline of the present invention.

FIG. 15 is a block diagram showing another exemplary structure of the present invention.

FIG. 16 is a block diagram showing another exemplary structure of the present invention.

FIG. 17 is a block diagram showing another exemplary structure of the present invention.

### DESCRIPTION OF EMBODIMENTS

### First Embodiment

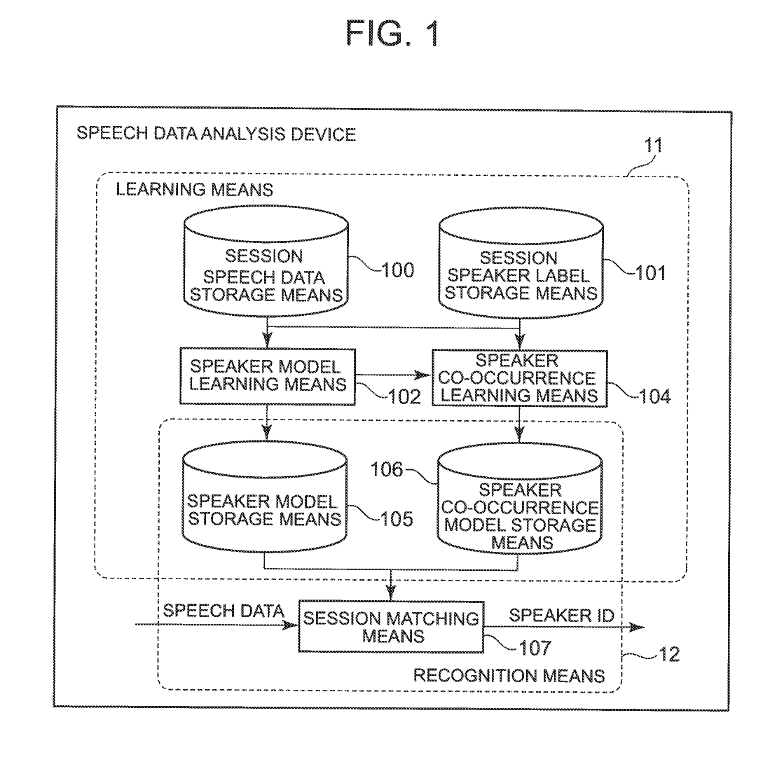

Embodiments according to the present invention will be described below with reference to the drawings. FIG. 1 is a block diagram showing an exemplary structure of a speech data analysis device according to a first embodiment of the present invention. As shown in FIG. 1, the speech data analysis device according to the present embodiment comprises a learning means 11 and a recognition means 12.

The learning means 11 includes a session speech data storage means 100, a session speaker label storage means 101, a speaker model learning means 102, a speaker co-occurrence learning means 104, a speaker model storage means 105, and a speaker co-occurrence model storage means 106.

The recognition means 12 includes a session matching means 107, the speaker model storage means 105 and the speaker co-occurrence model storage means 106. It shares the speaker model storage means 105 and the speaker co-occurrence model storage means 106 with the learning means 11.

The means schematically operate as follows. At first, the learning means 11 uses speech data and a speaker label to learn a speaker model and a speaker co-occurrence model in response to the operation of each means included in the learning means 11.

In the present embodiment, the session speech data storage means 100 stores therein many items of speech data used by the speaker model learning means 102 for learning. The speech data may be a voice signal recorded by any recorder or a converted characteristic vector series such as Mel Cepstram coefficient (MFCC). A time length of the speech data is not particularly limited, but is preferably longer, typically. Each item of speech data is configured of multiple speakers in addition to a single speaker's vocal form, and contains speech data generated when speakers speak in turns. For example, in the case of bank transfer scam, the speech data includes speech data taken from a lone criminal and speech data spoken on the phone by members in a group of criminals. Each item of speech data recorded as a series of conversation is called “session.” In the case of bank transfer scam, one crime corresponds to one session.

It is assumed that non-voice sections are removed from each item of speech data to be divided into proper units. A division unit is called “utterance” below. If not divided, only voice sections can be detected by a voice detection means (not shown) and can be easily converted into a divided form.

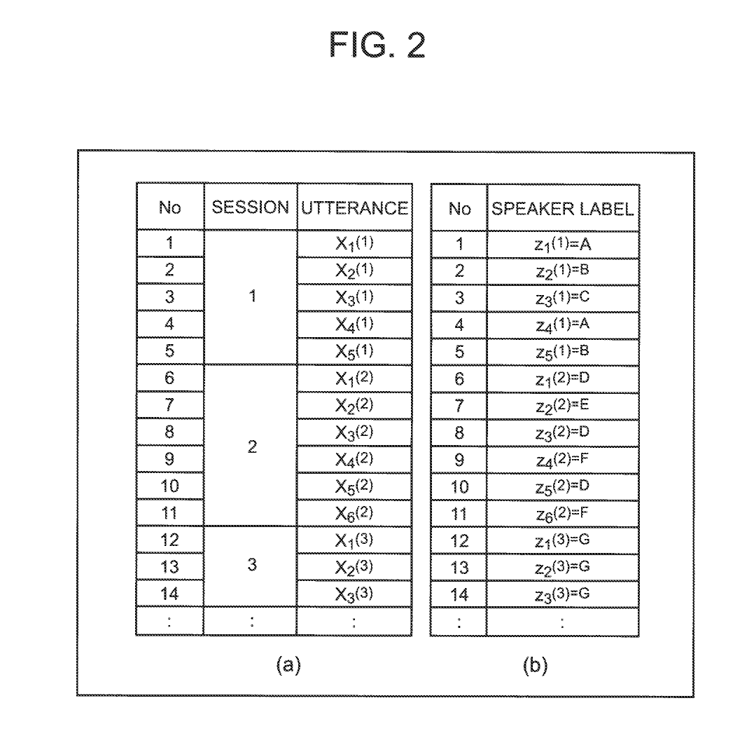

The session speaker label storage means 101 stores therein a speaker label used by the speaker model learning means 102 and the speaker co-occurrence learning means 104 for learning. The speaker label is an ID which is given to each utterance in each session and is directed for uniquely specifying a speaker. FIG. 2 is an explanatory diagram showing exemplary information stored in the session speech data storage means 100 and the session speaker label storage means 101. FIG. 2(a) shows exemplary information stored in the session speech data storage means 100 and FIG. 2(b) shows exemplary information stored in the session speaker label storage means 101. In the example shown in FIG. 2(a), the session speech data storage means 100 stores therein utterances Xₖ⁽ⁿ⁾ configuring each session. In the example shown in FIG. 2(b), the session speaker label storage means 101 stores therein speaker labels zₖ⁽ⁿ⁾ corresponding to individual utterances. Xₖ⁽ⁿ⁾ and zₖ⁽ⁿ⁾ indicate the k-th utterance and speaker label in the n-th session, respectively. Xₖ⁽ⁿ⁾ is typically treated as a characteristic vector series such as Mel Cepstram coefficient (MFCC) as in Formula (1), for example. Here, Lₖ⁽ⁿ⁾ is the number of frames in the utterance Xₖ⁽ⁿ⁾, or a length.

[Equation 1]

Xₖ⁽ⁿ⁾=(x_{k,1}⁽ⁿ⁾, x_{k,2}⁽ⁿ⁾, . . . , x_{k,L}_{ₖ}_{⁽}n)⁽ⁿ⁾) Formula (1)

The speaker model learning means 102 uses the speech data and the speaker label stored in the session speech data storage means 100 and the session speaker label storage means 101, respectively, to learn each speaker model. For example, the speaker model learning means 102 assumes a model (mathematical formula model such as probability model) defining a voice property per speaker as a speaker model, for example, and derives its parameters. A specific learn method may conform to Non-Patent Literature 1. That is, for each of the speaker A, the speaker B, the speaker C, . . . , all the utterances given with the speaker labels may be used from a set of items of data as shown in FIG. 2 to find parameters of a probability model (such as Gaussian mixed model (GMM)) defining an appearance probability of the voice characteristic amount per speaker.

The speaker co-occurrence learning means 104 uses the speech data stored in the session speech data storage means 100, the speaker label stored in the session speaker label storage means 101 and each speaker model found by the speaker model learning means 102 to learn a speaker co-occurrence model in which co-occurrence relationships between speakers are collected. As described in Technical Problem, a strength of the human relationship is present between speakers. Assuming that a connection between speakers is a network, the networks are not homogeneous, and some are strong and others are weak. When the networks are largely observed, sub-networks (clusters) having a particularly strong connection appear dispersed therein.

The learning by the speaker co-occurrence learning means 104 extracts such clusters and derives a mathematical formula model (probability model) indicative of a characteristic of the cluster.

The operations of the speaker model learning means 102 and the speaker co-occurrence learning means 104 will be described below in more detail.

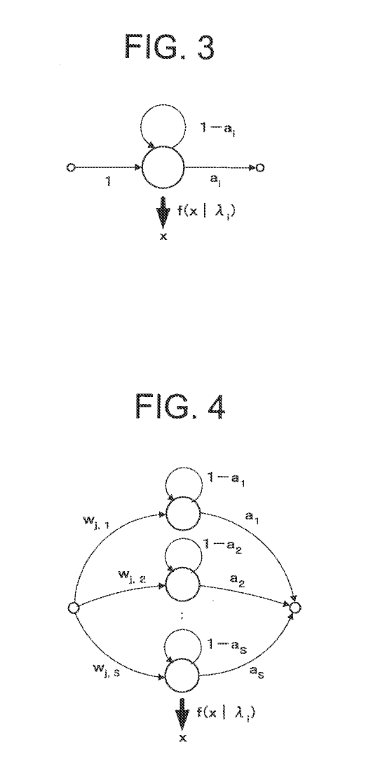

At first, a speaker model to be learned by the speaker model learning means 102 is a probability model defining a probability distribution of utterance X, and can be expressed in the state transition diagram of FIG. 3, for example. Strictly, a model of a speaker i (i=1, 2, . . . , S) is expressed by a probability density function of the following Formula (2).

$$\begin{matrix}[ Equation 2 ] & \\ \begin{matrix}p ( X \vert {a}_{i} , {λ}_{i} ) = p ( {x}_{1} , … , {x}_{L} \vert {a}_{i} , {λ}_{i} ) \\ = {( 1 - {a}_{i} )}^{L - 1} {a}_{i} {\prod }_{t = 1}^{L} f ( {x}_{t} \vert {λ}_{i} )\end{matrix} & Formula ( 2 )\end{matrix}$$

Such a probability model is called 1-state hidden Markov model. Particularly the parameter aᵢ is called state transition probability. f is a function defined by the parameter λᵢ and defines a distribution of individual characteristic vectors xᵢ configuring the utterance. The entity of the speaker model is the parameters aᵢ and λᵢ and the learning by the speaker model learning means 102 is to determine such values of the parameters. A specific function form of f may be a Gaussian mixed distribution (GMM). The speaker model learning means 102 calculates the parameters aᵢ and λᵢ and records them in the speaker model storage means 105 based on the learn method.

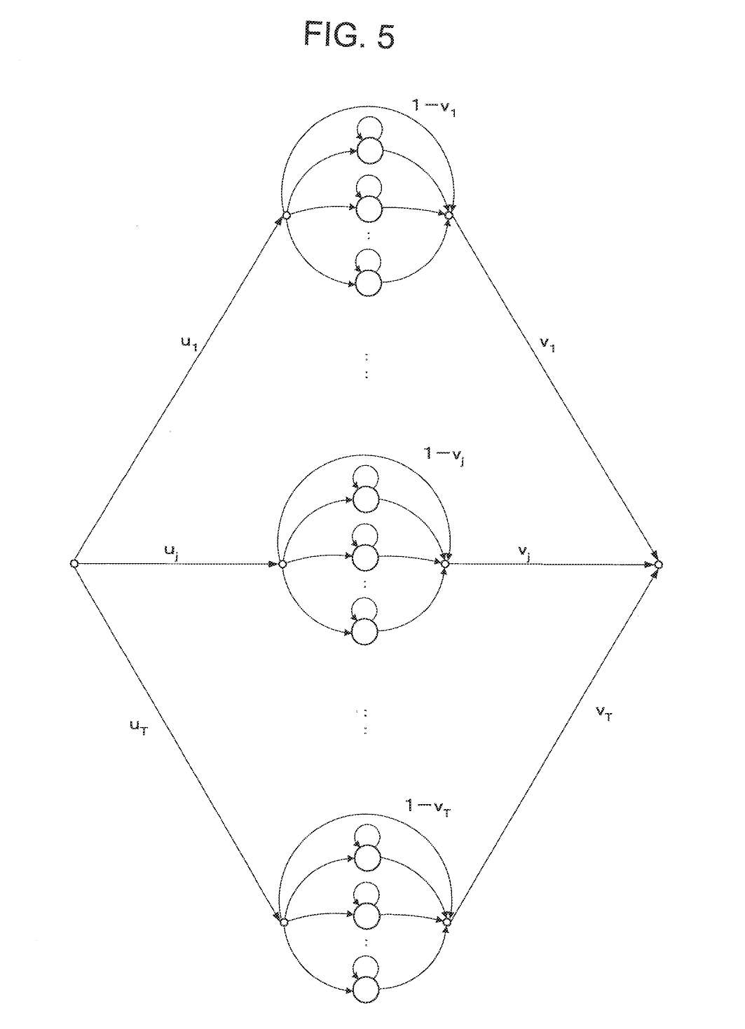

Then, assuming that the state transition diagram shown in FIG. 4 in which the speaker models of the above speakers (i=1, 2, . . . , S) are arranged in parallel to each other is a basic unit, the speaker co-occurrence model learned by the speaker co-occurrence learning means 104 can be expressed in the state transition diagram (Markov network) shown in FIG. 5 in which T units are further arranged in parallel.

wⱼᵢ (j=1, 2, . . . , T, i=1, 2, . . . , S) in FIG. 4 is a parameter (w_{j,1}+ . . . +w_{i,s}=1) indicating an appearance probability of the speaker i in the set of speakers (cluster) j and has T different patterns depending on j. At wⱼᵢ=0, the speaker i will never appear. Inversely, the speakers with wⱼᵢ>0 may co-occur each other, that is, have a human relationship. A collection of speakers with wⱼᵢ>0 corresponds to a cluster in the speakers' network, and indicates one typical criminal group in the example of theater company type bank transfer scam.

While FIG. 4 indicates a group of bank transfer scam criminals, a probability model expressed by a Markov network in FIG. 5 assumes that the criminal groups are largely classified into T patterns. uⱼ is a parameter indicating an appearance probability of a group of criminals, that is, a set of speakers (cluster) j, and can be interpreted as how active the activity of the group of criminals is. vⱼ is a parameter of the number of utterances in one session in the set of speakers j. The entity of the speaker co-occurrence model is the parameters uᵢ, vᵢ and wⱼᵢ, and the learning by the speaker co-occurrence learning means 104 is to determine the values of the parameters.

When a set of defined parameters is assumed as θ={uⱼ, vⱼ, wⱼᵢ, aᵢ, λᵢ}, a probability model defining a probability distribution of a session Ξ=(X₁, X₂, . . . , Xₖ) made of K utterances is expressed by the following Formula (3).

$$\begin{matrix} [ Equation 3 ] & \\ \begin{matrix}P ( Ξ \vert θ ) = {\sum }_{y , z} p ( Ξ , y , Z \vert θ ) \\ = {\sum }_{y , Z} {{u}_{y} ( 1 - {v}_{y} )}^{K - 1} {v}_{y} {\prod }_{k = 1}^{K} {w}_{{yZ}_{k}} F ( {X}_{k} \vert {a}_{{Z}_{k}} , {λ}_{{Z}_{k}} )\end{matrix} & Formula ( 3 )\end{matrix}$$

Where y is an index designating a set of speakers (cluster) and Z=(zᵢ, z₂, . . . , zₖ) is an index sequence designating a speaker per utterance. Formula (3) is replaced by the following Formula (4) for exemplified denotation.

$$\begin{matrix}[ Equation 4 ] & \\ F ( {X}_{k} \vert {a}_{{Z}_{k}} , {λ}_{{Z}_{k}} ) = {( 1 - {a}_{{Z}_{k}} )}^{{L}_{k} - 1} {α}_{{Z}_{k}} {\prod }_{t = 1}^{{L}_{k}} f ( {x}_{kt} \vert {λ}_{{Z}_{k}} ) & Formula ( 4 )\end{matrix}$$

The speaker co-occurrence learning means 104 uses the speech data Xₖ⁽ⁿ⁾ stored in the session speech data storage means 100, the speaker label zₖ⁽ⁿ⁾ stored in the session speaker label storage means 101 and the models aᵢ, λᵢ of each speaker found by the speaker model learning means 102 to estimate the parameters uⱼ, vⱼ and wⱼᵢ. Some estimation methods are possible and a likelihood maximization criterion (maximum likelihood criterion) method is typical. That is, the given speech data, the speaker label and each speaker model are estimated such that the probability p (Ξ|θ) in the following Formula (3) is maximum.

A specific calculation based on the maximum likelihood criterion can be derived by an expectation-maximization method (EM method), for example. Specifically, in steps S0 to S3 described later, an algorithm of alternately repeating step S1 and step S2 is performed.

Step S0:

Set the parameters uⱼ, vⱼ and wⱼᵢ at proper values.

Step S1:

A probability that the session Ξ⁽ⁿ⁾ belongs to the cluster y is calculated according to the following Formula (5). Where K⁽ⁿ⁾ is the number of utterances included in the session Ξ⁽ⁿ⁾.

$$\begin{matrix} [ Equation 5 ] & \\ P ( y \vert {Ξ}^{( n )} , θ ) = \frac{{{u}_{y} ( 1 - {v}_{y} )}^{{K}^{( n )} - 1} {v}_{y} {\prod }_{k = 1}^{{K}^{( n )}} {\sum }_{i = 1}^{S} {w}_{{yZ}_{k}^{( n )}} F ( {X}_{k} \vert {a}_{i} , {λ}_{i} )}{\begin{matrix}{\sum }_{j = 1}^{T} {{u}_{j} ( 1 - {v}_{n} )}^{{K}^{( n )} - 1} {v}_{j} \\ {\prod }_{k = 1}^{{K}^{( n )}} {\sum }_{i = 1}^{S} {w}_{{jZ}_{k}^{( n )}} F ( {X}_{k} \vert {a}_{i} , {λ}_{i} )\end{matrix}} & Formula ( 5 )\end{matrix}$$

Step S2:

Update the parameters uⱼ, vⱼ and wⱼᵢ according to the following Formula (6). Where N is the total number of sessions and δᵢⱼ is a Kronecker delta.

$$\begin{matrix}[ Equation 6 ] & \\ {u}_{y} ← \frac{1}{N} {\sum }_{n = 1}^{N} p ( y \vert {Ξ}^{( n )} , θ ) & Formula ( 6 ) \\ {v}_{y} ← \frac{{\sum }_{n = 1}^{N} p ( y \vert {Ξ}^{( n )} , θ )}{{\sum }_{n = 1}^{N} {K}^{( n )} p ( y \vert {Ξ}^{( n )} , θ )} & \\ {w}_{yz} ← \frac{{\sum }_{n = 1}^{N} {\sum }_{k = 1}^{{K}^{( n )}} {δ}_{{zz}_{k}^{( n )}} p ( y \vert {Ξ}^{( n )} , θ )}{{\sum }_{n = 1}^{N} {K}^{( n )} p ( y \vert {Ξ}^{( n )} , θ )} & \end{matrix}$$

Step S3:

Subsequently, a convergence determination is made based on such as a degree of increase in the probability p(Ξ|θ) in the above Formula (3), and step S1 and step S2 are alternately repeated until the convergence.

The speaker co-occurrence model calculated through the above steps or the parameters uⱼ, vⱼ and wⱼᵢ are recorded in the speaker co-occurrence model storage means 106.

The recognition means 12 recognizes a speaker included in any given speech data through the operations of the respective means included in the recognition means 12.

In the present embodiment, the session matching means 107 receives arbitrary speech data. The speech data here includes speech data generated in a utterance sequence form in which multiple speakers speak in turns, in addition to a single speaker's utterance similar to the speech data handled by the learning means 11. The speech data is expressed as Ξ=(X₁, X₂, . . . , Xₖ) as described above, and Ξ is called session.

The session matching means 107 estimates from which speaker each utterance included in the session Ξ was originated, that is, the speaker label sequence Z=(z₂, z₂, zₖ) with reference to the speaker model and the speaker co-occurrence model which are previously calculated by the learning means 11 and are recorded in the speaker model storage means 104 and the speaker co-occurrence model storage means 106, respectively. Specifically, given the session speech data Ξ and the parameter θ={uⱼ, vⱼ, wⱼᵢ, aᵢ, λᵢ}, a probability distribution of the speaker label sequence Z can be theoretically calculated based on the following Formula (7).

$$\begin{matrix} [ Equation 7 ] & \\ p ( Z \vert Ξ , θ ) = \frac{{\sum }_{j = 1}^{T} {{u}_{n} ( 1 - {v}_{j} )}^{K - 1} {v}_{j} {\prod }_{k = 1}^{K} {w}_{{jz}_{k}} F ( {X}_{k} \vert {a}_{{z}_{k}} , {λ}_{{z}_{k}} )}{{\sum }_{j = 1}^{T} {{u}_{n} ( 1 - {v}_{j} )}^{K - 1} {v}_{j} {\prod }_{k = 1}^{K} {\sum }_{i = 1}^{S} {w}_{ji} F ( {X}_{k} \vert {a}_{i} , {λ}_{i} )} & Formula ( 7 )\end{matrix}$$

Thus, Z is found such that the probability p (Ξ|θ) is maximum, so that the speaker label of each utterance can be calculated. The denominator in the right-hand side in Formula (7) is a constant not depending on Z, and its calculation can be omitted. The total sum of the clusters j in the numerator may be replaced with the maximum value operation maxⱼ for approximate calculation as is often made in this kind of calculations. Further, S^{K} combinations of the possible values of Z are present and the calculation amount of the maximum value search of the probability p(Ξ|θ) may be significantly increased, but the search can be efficiently made with a calculation method such as dynamic programming method.

The aforementioned operation assumes that the speech data input into the recognition means 12 is configured of only the utterances of the speakers learned by the learning means 11. However, for actual applications, the speech data including a utterance of an unknown speaker, which was not able to be obtained by the learning means 11, may be input. In such a case, a post-processing of determining whether each utterance is of an unknown speaker can be easily introduced. That is, a probability that an individual utterance Xₖ belongs to a speaker zₖ is calculated by Formula (8), and when the probability is equal to or less than a predetermined threshold, it may be determined that the utterance is of an unknown speaker.

$$\begin{matrix} [ Equation 8 ] & \\ p ( {z}_{k} \vert Ξ , θ ) = & Formula ( 8 ) \\ \frac{\begin{matrix}{\sum }_{j = 1}^{T} {{u}_{j} ( 1 - {v}_{j} )}^{K - 1} {v}_{j} \{ {\prod }_{{k}^{′} = 1}^{k - 1} {\sum }_{i = 1}^{S} {w}_{ji} F ( {X}_{{k}^{′}} \vert {a}_{i} , {λ}_{i} ) \} {w}_{{jz}_{k}} \\ F ( {X}_{k} \vert {a}_{{z}_{k}} , {λ}_{{z}_{k}} ) \{ {\prod }_{{k}^{′} = k + 1}^{k - 1} {\sum }_{i = 1}^{S} {w}_{ji} F ( {X}_{{k}^{′}} \vert {a}_{i} , {λ}_{i} ) \}\end{matrix}}{{\sum }_{j = 1}^{T} {{u}_{j} ( 1 - {v}_{j} )}^{K - 1} {v}_{j} {\prod }_{{k}^{′} = 1}^{K} {\sum }_{i = 1}^{S} {w}_{ji} F ( {X}_{{k}^{′}} \vert {a}_{i} , {λ}_{i} )} & \end{matrix}$$

Alternatively, the approximate calculation expressed in the following Formula (9) may be made instead of the above Formula (8).

$$\begin{matrix}[ Equation 9 ] & \\ p ( {z}_{k} \vert {X}_{k} , θ ) \approx \frac{{\sum }_{j = 1}^{T} {w}_{{jz}_{k}} F ( {X}_{k} \vert {a}_{{z}_{k}} , {λ}_{{z}_{k}} )}{{\sum }_{j = 1}^{T} {\sum }_{i = 1}^{S} {w}_{ji} F ( {X}_{{k}^{′}} \vert {a}_{i} , {λ}_{i} )} & Formula ( 9 )\end{matrix}$$

The right-hand sides in Formula (8) and Formula (9) include a total sum of speaker models i=1, . . . , S, and may be replaced by an average speaker model described in Non-Patent Literature 1 or a universal background model for calculation.

In the present embodiment, the session speech data storage means 100, the session speaker label storage means 101, the speaker model storage means 105 and the speaker co-occurrence model storage means 106 are implemented by storage devices such as memories. The speaker model learning means 102, the speaker co-occurrence learning means 104 and the session matching means 107 are implemented by an information processing device (processor unit) such as CPU operating according to programs. The session speech data storage means 100, the session speaker label storage means 101, the speaker model storage means 105 and the speaker co-occurrence model storage means 106 may be implemented as independent storage devices. The speaker model learning means 102, the speaker co-occurrence learning means 104 and the session matching means 107 may be implemented as independent units.

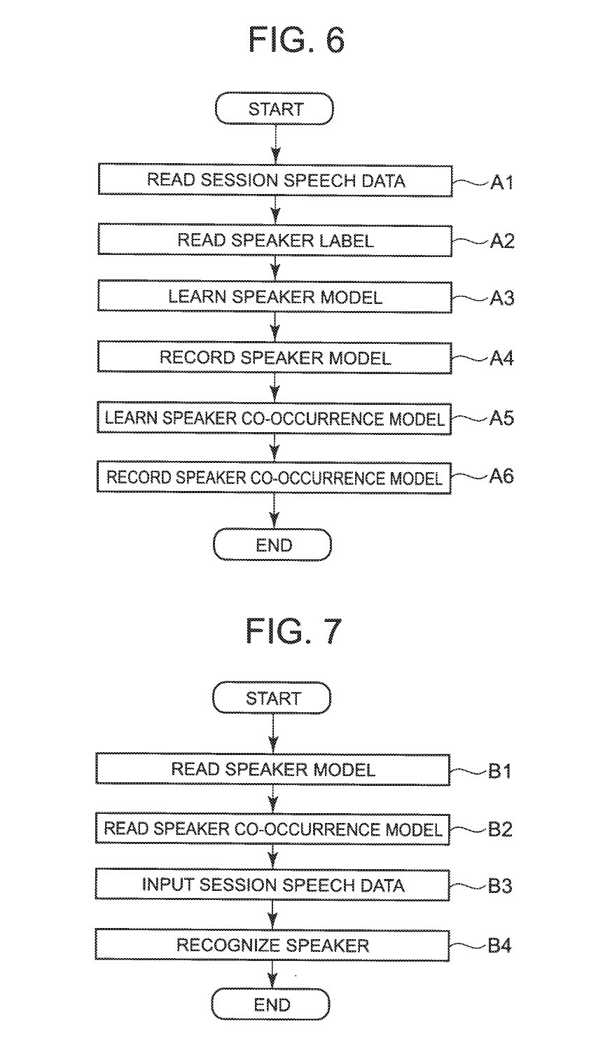

The entire operations of the present embodiment will be described below in detail with reference to the flowcharts of FIG. 6 and FIG. 7. FIG. 6 is a flowchart showing exemplary operations of the learning means 11. FIG. 7 is a flowchart showing exemplary operations of the recognition means 12.

In the learning means 11, the speaker model learning means 102 and the speaker co-occurrence model learning means 104 read speech data from the session speech data storage means 100 (step A1 in FIG. 6). They read a speaker label from the session speaker label storage means 101 (step A2). The items of data are read in an arbitrary order. The speaker model learning means 102 and the speaker co-occurrence model learning means 104 may not read data at the same timing.

Then, the speaker model learning means 102 uses the read speech data and speaker label to calculate each speaker model or the parameters aᵢ and λᵢ (i=1, . . . , S) (step A3) and to record the same in the speaker model storage means 105 (step A4).

The speaker co-occurrence learning means 104 uses the speech data, the speaker label and each speaker model calculated by the speaker model learning means 102 to make predetermined calculations such as iterative solution techniques including the calculations of the above Formula (5) and Formula (6), thereby to calculate the speaker co-occurrence model or the parameters uⱼ, vⱼ and wⱼᵢ (i=1, . . . , S, j=1, . . . , T) (step A5) and to record the same in the speaker co-occurrence model storage means 106 (step A6).

On the other hand, in the recognition means 12, the session matching means 107 reads a speaker model from the speaker model storage means 105 (step B1 in FIG. 7) and reads a speaker co-occurrence model from the speaker co-occurrence model storage means 106 (step B2). It receives arbitrary speech data (step B3) and makes predetermined calculations of the above Formula (7) and, as needed, Formula (8) or Formula (9), for example, thereby to find a speaker label of each speaker of the received speech data.

As described above, according to the present embodiment, in the learning means 11, the speaker co-occurrence learning means 104 uses the speech data and the speaker label recorded in units of session putting a series of utterances in a conversation together, thereby to acquire (generate) a co-occurrence relationship between the speakers as a speaker co-occurrence model. In the recognition means 12, the session matching means 107 uses the speaker co-occurrence model acquired by the learning means 11 to recognize the speakers in consideration of the co-occurrence consistency of the speakers in the total session, not independently recognizing a speaker for an individual utterance. Thus, the speaker label can be accurately found and the speakers can be recognized with high accuracy.

For example, for bank transfer scam, there is a relationship between speakers in the case of multiple criminals in a theater company type bank transfer scam. For example, a speaker A and a speaker B belong to the same crime group and are likely to appear in one crime (on the phone), or the speaker B and a speaker C are in different crime groups and do not appear together, or a speaker D is always a lone criminal. It is called “co-occurrence” in the present invention that a speaker and another speaker such as the speaker A and the speaker B appear together.

Such a relationship between speakers is important information for specifying the speakers or criminals. Particularly, the voices obtained on the phone are narrow in band and are deteriorated in sound quality, and thus the speakers are difficult to discriminate. Thus, the assumption that “the speaker A speaks there and the voice here may be of the speaker B” is estimated to be effective. Therefore, the above configuration is employed to recognize the speakers in consideration of the relationship between the speakers, thereby achieving the object of the present invention.

### Second Embodiment

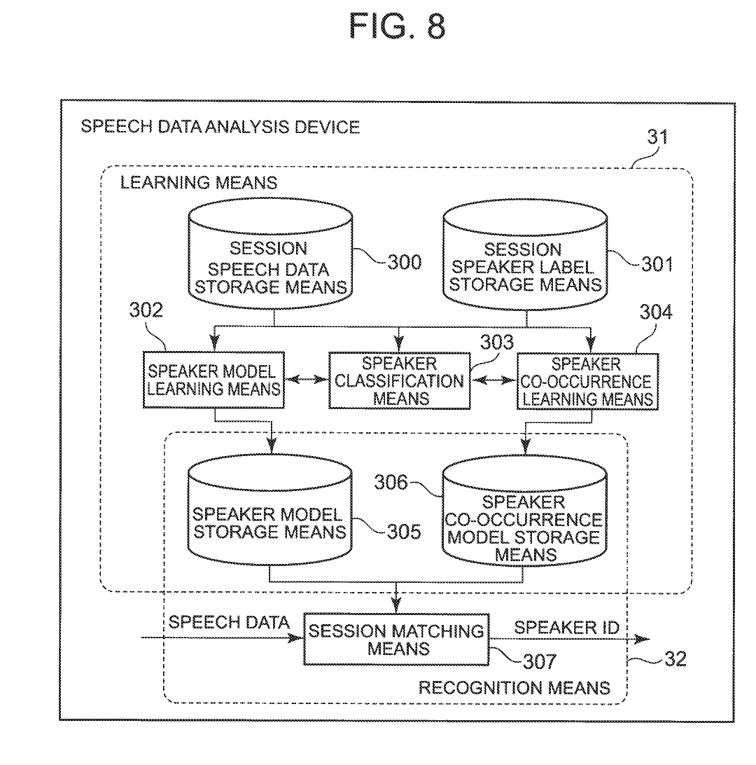

A second embodiment according to the present invention will be described below. FIG. 8 is a block diagram showing an exemplary structure of a speech data analysis device according to the second embodiment of the present invention. As shown in FIG. 8, the speech data analysis device according to the present embodiment comprises a learning means 31 and a recognition means 32.

The learning means 31 includes a session speech data storage means 300, a session speaker label storage means 301, a speaker model learning means 302, a speaker classification means 303, a speaker co-occurrence learning means 304, a speaker model storage means 305 and a speaker co-occurrence model storage means 306. The present embodiment is different from the first embodiment in that the speaker classification means 303 is included.

The recognition means 32 includes a session matching means 307, a speaker model storage means 304 and a speaker co-occurrence model storage means 306. The speaker model storage means 304 and the speaker co-occurrence model storage means 306 are shared with the learning means 31.

Each of the means schematically operates as follows.

The learning means 31, similar to the first embodiment, uses speech data and a speaker label to learn a speaker model and a speaker co-occurrence model through the operations of the respective means included in the learning means 31. However, the speaker label may be incomplete unlike the learning means 11 according to the first embodiment. That is, a speaker label corresponding to partial session in the speech data or partial utterance may be unknown. Typically, a work of giving a speaker label to each utterance needs enormous personal costs for checking the speech data, and the like, and thus the above situation often occurs in actual applications.

The session speech data storage means 300 and the session speaker label storage means 301 are the same as the session speech data storage means 100 and the session speaker label storage means 101 according to the first embodiment except for that partial speaker label is unknown.

The speaker model learning means 302 uses the speech data and the speaker label stored in the session speech data storage means 300 and the session speaker label storage means 301, respectively, as well as the estimation result of an unknown speaker label calculated by the speaker classification means 303 and the estimation result of each session belonging cluster calculated by the speaker co-occurrence learning means 304 to learn each speaker model and then to record a final speaker model in the speaker model storage means 305.

The speaker classification means 303 uses the speech data and the speaker label stored in the session speech data storage means 300 and the session speaker label storage means 301, respectively, as well as the speaker model calculated by the speaker model learning means 302 and the speaker co-occurrence model calculated by the speaker co-occurrence learning means 304 to stochastically estimate a speaker label to be given to the utterance of the unknown speaker label.

The speaker co-occurrence learning means 304 stochastically estimates a belonging cluster per session, and learns a speaker co-occurrence model with reference to the estimation result of the unknown speaker label calculated by the speaker classification means 303. The final speaker co-occurrence model is recorded in the speaker co-occurrence storage means 306.

The operations of the speaker model learning means 302, the speaker classification means 303 and the speaker co-occurrence learning means 304 will be described in more detail.

The speaker model learned by the speaker model learning means 302 and the speaker co-occurrence model learned by the speaker co-occurrence learning means 304 are the same as those in the first embodiment and are represented by the state transition diagrams in FIG. 3 and FIG. 5, respectively. Since the speaker label is incomplete, the speaker model learning means 302, the speaker classification means 303 and the speaker co-occurrence learning means 304 depend on each other's output, and repeatedly operate in turns to learn a speaker model and a speaker co-occurrence model. Specifically, in steps S30 to S35 described later, the estimation is made by the algorithm of repeating steps S31 to S34.

Step S30:

The speaker co-occurrence learning means 304 sets the parameters uⱼ, vⱼ and wⱼᵢ (i=1, . . . , S, j=1, . . . , T) of the speaker co-occurrence model at proper values. The speaker classification means 303 gives a proper label (value) such as random number to an unknown speaker label.

Step S31:

The speaker model learning means 302 uses the speech data recorded in the session speech data storage means 300, the previously-known speaker label recorded in the session speaker label storage means 301, and the speaker label estimated by the speaker classification means 303 to learn a speaker model and to update the parameters aᵢ and λᵢ (i=1, . . . , S). For example, when the speaker model is a Gaussian distribution model defined by the average μᵢ and the dispersion Σᵢ, that is, λᵢ, μᵢ, Σᵢ), the parameters are updated by the following Formula (10).

$$\begin{matrix} [ Equation 10 ] & \\ {a}_{z} ← \frac{{\sum }_{n = 1}^{N} {\sum }_{k = 1}^{{K}^{( n )}} {\sum }_{y = 1}^{T} p ( y \vert {Ξ}^{( n )} , θ ) p ( z \vert y , {X}_{k}^{( n )} , θ )}{{\sum }_{n = 1}^{N} {\sum }_{k = 1}^{{K}^{( n )}} {\sum }_{y = 1}^{T} {L}_{k}^{( n )} p ( y \vert {Ξ}^{( n )} , θ ) p ( z \vert y , {X}_{k}^{( n )} , θ )} & Formula ( 10 ) \\ {u}_{z} ← \frac{{\sum }_{n = 1}^{N} {\sum }_{k = 1}^{{K}^{( n )}} {\sum }_{y = 1}^{T} {\sum }_{t = 1}^{{L}_{k}^{( n )}} {x}_{kt}^{( n )} p ( y \vert {Ξ}^{( n )} , θ ) p ( z \vert y , {X}_{k}^{( n )} , θ )}{{\sum }_{n = 1}^{N} {\sum }_{k = 1}^{{K}^{( n )}} {\sum }_{y = 1}^{T} {\sum }_{t = 1}^{{L}_{k}^{( n )}} p ( y \vert {Ξ}^{( n )} , θ ) p ( z \vert y , {X}_{k}^{( n )} , θ )} & \\ {\sum }_{z} ← \frac{\begin{matrix}{\sum }_{n = 1}^{N} {\sum }_{k = 1}^{{K}^{( n )}} {\sum }_{y = 1}^{T} {{\sum }_{t = 1}}^{{L}_{k}^{( n )}} {x}_{kt}^{( n )} {x}_{kt}^{{( n )}^{T}} \\ p ( y \vert {Ξ}^{( n )} , θ ) p ( z \vert y , {X}_{k}^{( n )} , θ )\end{matrix}}{{\sum }_{n = 1}^{n} {\sum }_{k = 1}^{{K}^{( n )}} {\sum }_{y = 1}^{T} {\sum }_{t = 1}^{{L}_{k}^{( n )}} p ( y \vert {Ξ}^{( n )} , θ ) p ( z \vert y , {X}_{k}^{( n )} , θ )} - {u}_{z} {u}_{z}^{T} & \end{matrix}$$

Step S32:

The speaker classification means 303 uses the speech data recorded in the session speech data storage means 300, the speaker model and the speaker co-occurrence model to stochastically estimate a speaker label for the utterance of the unknown speaker label according to the following Formula (11).

$$\begin{matrix}[ Equation 11 ] & \\ p ( y , {X}_{k}^{( n )} , θ ) = \frac{{w}_{yz} F ( {X}_{k}^{( n )} \vert {a}_{z} , {λ}_{z} )}{{\sum }_{i = 1}^{S} {w}_{yi} F ( {X}_{k}^{( n )} \vert {a}_{i} , {λ}_{i} )} & Formula ( 11 )\end{matrix}$$

Step S33:

The speaker co-occurrence learning means 304 uses the speech data and the previously-known speaker label recorded in the session speech data storage means 300 and the session speaker label storage means 301, respectively, as well as the speaker model calculated by the speaker model learning means 302 and the estimation result of the unknown speaker label calculated by the speaker classification means 303 to calculate a probability that the session Ξ⁽ⁿ⁾ belongs to the cluster y according to the above Formula (5).

Step S34:

The speaker co-occurrence learning means 304 uses the calculation result in step S33 to learn a speaker co-occurrence model. That is, the parameters uⱼ, vⱼ and wⱼᵢ (i=1, . . . , S, j=1, . . . , T) are updated according to the following Formula (12).

$$\begin{matrix}[ Equation 12 ] & \\ {u}_{y} ← \frac{1}{N} {\sum }_{n = 1}^{N} p ( y \vert {Ξ}^{( n )} , θ ) & Formula ( 12 ) \\ {v}_{y} ← \frac{{\sum }_{n = 1}^{N} p ( y \vert {Ξ}^{( n )} , θ )}{{\sum }_{n = 1}^{N} {K}^{( n )} p ( y \vert {Ξ}^{( n )} , θ )} & \\ {w}_{yz} ← \frac{{\sum }_{n = 1}^{N} {\sum }_{k = 1}^{{K}^{( n )}} p ( y \vert {Ξ}^{( n )} , θ ) p ( z \vert y , {X}_{k}^{( n )} , θ )}{{\sum }_{{z}^{′} = 1}^{S} {\sum }_{n = 1}^{N} {\sum }_{k = 1}^{{K}^{( n )}} p ( y \vert {Ξ}^{( n )} , θ ) p ( {z}^{′} \vert y , {X}_{k}^{( n )} , θ )} & \end{matrix}$$

Step S35:

Subsequently, steps S31 to S34 are repeated until the convergence is obtained. When the convergence is reached, the speaker model learning means 302 records the speaker model in the speaker model storage means 305 and the speaker co-occurrence learning means 304 records the speaker co-occurrence model in the speaker co-occurrence model storage means 306, respectively.

The processing in steps S31 to S35 are derived by the expectation maximization method based on the likelihood maximization criterion similar to the first embodiment. The derivation is exemplary, and formulation based on other well-known criterion such as maximum a posterior probability (MAP) criterion or Bayesian criterion is also possible.

The recognition means 32 according to the present embodiment recognizes a speaker included in any given speech data through the operations of the respective means included in the recognition means 32. The details of the operations are the same as those in the recognition means 12 in the first embodiment and the explanation thereof will be omitted.

In the present embodiment, for example, the session speech data storage means 300, the session speaker label storage means 301, the speaker model storage means 305 and the speaker co-occurrence model storage means 306 are implemented by storage devices such as memories. The speaker model learning means 302, the speaker classification means 303, the speaker co-occurrence learning means 304 and the session matching means 307 are implemented by an information processing device (processor unit) operating according to programs such as CPU. The session speech data storage means 300, the session speaker label storage means 301, the speaker model storage means 305, and the speaker co-occurrence model storage means 306 may be implemented as independent storage devices. The speaker model learning means 302, the speaker classification means 303, the speaker co-occurrence learning means 304 and the session matching means 307 may be implemented as independent units.

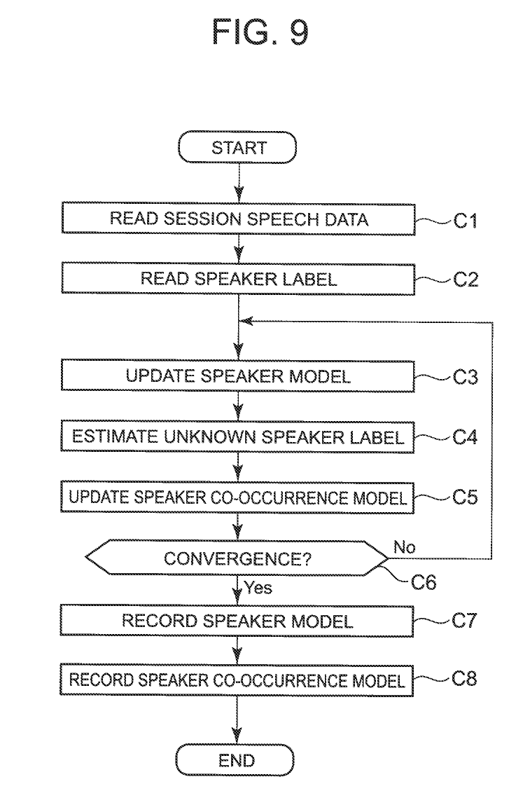

The operations of the present embodiment will be described below in detail with reference to the flowchart shown in FIG. 9. FIG. 9 is a flowchart showing exemplary operations of the learning means 31 according to the present embodiment. The operations of the recognition means 32 are the same as those in the first embodiment and thus the explanation thereof will be omitted.

The speaker model learning means 302, the speaker classification means 303 and the speaker co-occurrence learning means 304 read the speech data stored in the session speech data storage means 300 (step C1 in FIG. 9). The speaker model learning means 302 and the speaker co-occurrence learning means 304 further read the previously-known speaker label stored in the session speaker label storage means 301 (step C2).

The speaker model learning means 302 uses the estimation result of the unknown speaker label calculated by the speaker classification means 303 and the estimation result of the cluster to which each session belongs calculated by the speaker co-occurrence learning means 304 to update a speaker model (step C3).

The speaker classification means 303 receives the speaker model from the speaker model learning means 302 and the speaker co-occurrence model from the speaker co-occurrence learning means 304, respectively, and stochastically estimates a label to be given to the utterance of the unknown speaker label according to the above Formula (11), for example (step C4).

The speaker co-occurrence learning means 304 stochastically estimates the belonging cluster per session according to the above Formula (5), for example, and updates the speaker co-occurrence model according to the above Formula (12), for example, with reference to the estimation result of the unknown speaker label calculated by the speaker classification means 303 (step C5).

A convergence determination is made (step C6), and when the convergence has not been obtained, the processing returns to step C3. When the convergence has been reached, the speaker model learning means 302 records the speaker model in the speaker model storage means 305 (step C7) and the speaker co-occurrence learning means 304 records the speaker co-occurrence model in the speaker co-occurrence model storage means 306 (step C8).

The order of step C1 and step C2 and the order of step C7 and step C8 are arbitrary, respectively. The order of steps S33 to S35 may be arbitrarily rearranged.

As described above, since the present embodiment is configured such that even when the speaker label is unknown in the learning means 31, the speaker classification means 303 estimates the speaker label and repeatedly operates in cooperation with the speaker model learning means 302 and the speaker co-occurrence learning means 304 to obtain a speaker model and a speaker co-occurrence model, even when part of the speaker label is lacking or incomplete, the speaker can be recognized with high accuracy. Other points are the same as those in the first embodiment.

### Third Embodiment

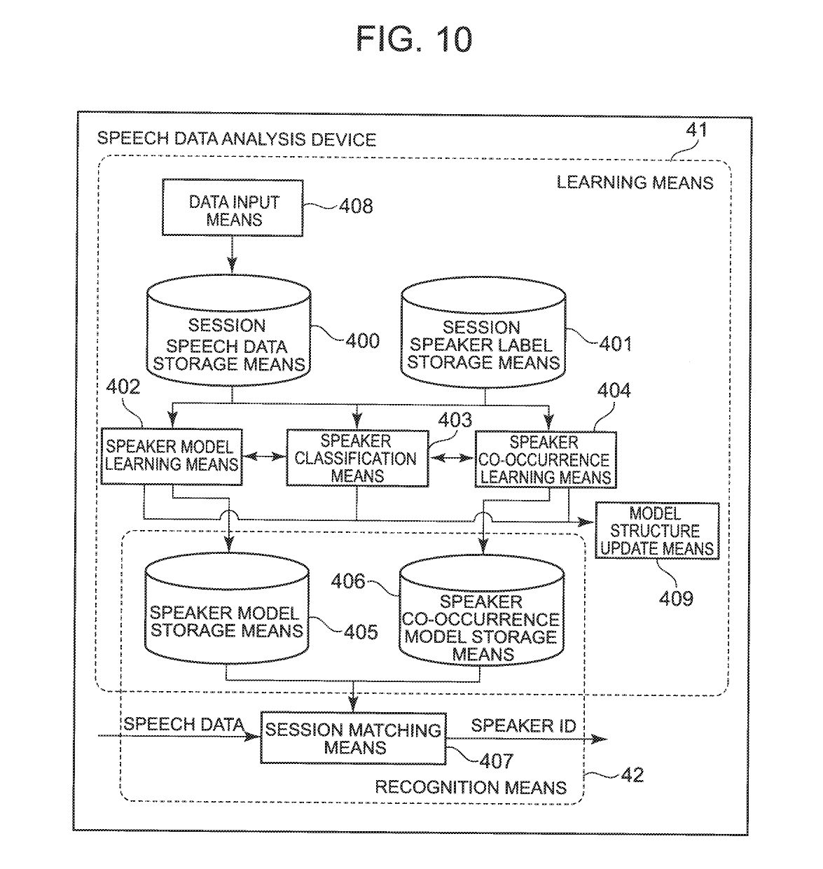

A third embodiment according to the present invention will be described below. FIG. 10 is a block diagram showing an exemplary structure of a speech data analysis device according to the third embodiment of the present invention. The present embodiment assumes that a speaker model and a speaker co-occurrence model change over time (such as months and days). That is, sequentially-input speech data is analyzed, and according to the analysis result, an increase/decrease in speakers, an increase/decrease in clusters as sets of speakers, and the like are detected to adapt the structures of the speaker model and the speaker co-occurrence model. The speakers and the relationship between the speakers typically change over time. The present embodiment is embodied in consideration of such a temporal change (over-time change).

As shown in FIG. 10, the speech data analysis device according to the present embodiment comprises a learning means 41 and a recognition means 42.

The learning means 41 includes a data input means 408, a session speech data storage means 400, a session speaker label storage means 401, a speaker model learning means 402, a speaker classification means 403, a speaker co-occurrence learning means 404, a speaker model storage means 405, a speaker co-occurrence model storage means 406 and a model structure update means 409. The present embodiment is different from the second embodiment in that the data input means 408 and the model structure update means 409 are included.

The recognition means 42 includes the session matching means 407, the speaker model storage means 404 and the speaker co-occurrence model storage means 406. The recognition means 42 and the learning means 41 share the speaker model storage means 404 and the speaker co-occurrence model storage means 406 with each other.

The means schematically operate as follows.

The learning means 41 operates such as the learning means 31 according to the second embodiment for its initial operations. That is, the speech data and the speaker label stored in the session speech data storage means 400 and the session speaker label storage means 401 at that time, respectively, are used to learn a speaker model and a speaker co-occurrence model by the operations of the speaker model learning means 104, the speaker classification means 403 and the speaker co-occurrence learning means 404 based on the number of speaker S and the number of clusters T which are previously defined. Then, the learned speaker model and speaker co-occurrence model are stored in the speaker model storage means 405 and the speaker co-occurrence model storage means 406, respectively.

Each means included in the learning means 41 operates as follows after the initial operations. The data input means 408 receives new speech data and a new speaker label and additionally records them in the speech data storage means 400 and the session speaker label storage means 401, respectively. Similar to the second embodiment, when the speaker label cannot be obtained for any reason, only the speech data is acquired and recorded in the speech data storage means 400.

The speaker model learning means 402, the speaker classification means 403 and the speaker co-occurrence learning means 404 operate as in steps S30 to S35 in the second embodiment with reference to each item of data recorded in the speech data storage means 400 and the session speaker label storage means 401. In step S40, the parameters of the speaker model and the speaker co-occurrence model obtained at that time are used unlike step S30 in the second embodiment.

Step S40:

The speaker co-occurrence learning means 404 sets the parameters uⱼ, vⱼ and wⱼᵢ (i=1, . . . S, j=1, . . . T) of the speaker co-occurrence model at proper values. The speaker classification means 403 uses the parameter values of the speaker model and the speaker co-occurrence model obtained at that time for the unknown speaker label to estimate a speaker label according to the above Formula (11).

Step S41:

The speaker model learning means 402 uses the previously-known speaker label recorded in the session speech data storage means 400 and the speaker label estimated in step S40 or step S42 described later to learn a speaker model and to update the parameters aᵢ and λᵢ (i=1, . . . , S). For example, when the speaker model is a Gaussian distribution model defined by the average μᵢ and the dispersion Σᵢ, that is, λi=(aᵢ, μᵢ, Σᵢ), the parameters are updated according to the above Formula (10).

Step S42:

The speaker classification means 403 uses the speech data recorded in the session speech data storage means 400 as well as the speaker model and the co-occurrence model to stochastically estimate a speaker label for the utterance of the unknown speaker label according to the above Formula (11).

Step S43:

The speaker co-occurrence learning means 404 uses the speech data and the previously-known speaker label recorded in the session speech data storage means 400 and the session speaker label storage means 401, respectively, as well as the speaker model calculated by the speaker model learning means 402 and the estimation result of the unknown speaker label calculated by the speaker classification means 403 to calculate a probability that the session Ξ⁽ⁿ⁾ belongs to the cluster y according to the above Formula (5).

Step S44:

The speaker co-occurrence learning means 404 further uses the calculation result in step S43 to learn a speaker co-occurrence model. That is, the parameters uⱼ, vⱼ and wⱼᵢ (i=1, . . . , S, j=1, . . . , T) are updated according to the above Formula (12).

Step S45:

Subsequently, steps S41 to S44 are repeated until the convergence is obtained. When the convergence is reached, the speaker model learning means 402 records the updated speaker model in the speaker model storage means 405 and the speaker co-occurrence learning means 404 records the updated speaker co-occurrence model in the speaker co-occurrence model storage means 406, respectively.

The processing in steps S41 to S45 are derived from the expectation maximization method based on the likelihood maximization criterion similar to the first and second embodiments. Formulation based on other well-known criterion such as maximum a posterior probability (MAP) criterion or Bayesian criterion is also possible.

The learning means 41 according to the present embodiment further operates as follows.

The model structure update means 409 receives new session speech data received by the data input means 408 as well as the speaker model, the speaker co-occurrence model and the speaker label from the speaker model learning means 402, the speaker co-occurrence learning means 404 and the speaker classification means 403, respectively, and detects the changes of the structures of the speaker model and the speaker co-occurrence model by a following method, for example, and generates a speaker model and a speaker co-occurrence model on which the changes of the structures are reflected.

The changes of the structures indicate six events described later. 1) Occurrence of a speaker: Anew speaker who has not been observed appears. 2) Disappearance of a speaker: A previously-known speaker does not appear. 3) Occurrence of a cluster: A new cluster (set of speakers) which has not been observed appears. 4) Disappearance of a cluster: An existing cluster does not appear. 5) Split-up of a cluster: An existing cluster is split into multiple clusters. 6) Merger of clusters: Existing clusters are put into one cluster together.

The model structure update means 409 detects the above six events as follows, and updates the structures of the speaker model and the speaker co-occurrence model according to the detection result.

For “1) Occurrence of a speaker,” an entropy of the speaker label defined by the above Formula (11) and the following Formula (13) for an individual utterance Xₖ⁽ⁿ⁾ (1≦k≦K⁽ⁿ⁾) included in the speech data is calculated.

$$\begin{matrix}[ Equation 13 ] & \\ - {\sum }_{z = 1}^{S} p ( z \vert y , {X}_{k}^{( n )} , θ ) log p ( z \vert y , {X}_{k}^{( n )} , θ ) & Formula ( 13 )\end{matrix}$$

When the value of the entropy is larger than a predetermined threshold, it is assumed that the utterance Xₖ⁽ⁿ⁾ is of a new speaker who does not adapt to any existing speaker, and thus the number of speakers S is incremented (added with 1) and the parameters a_{S+1} and λ_{S+1} of the new speaker model and the parameter w_{j,S+1} (1≦j≦T) of the corresponding speaker co-occurrence model are prepared to be set at proper values. The values may be determined at random numbers or may be determined by use of the statistics of the average or dispersion of the utterance Xₖ⁽ⁿ⁾.

For “2) Disappearance of a speaker,” the maximum value of the parameter w_{j,i} (1≦j≦T) of the speaker co-occurrence model is examined for each speaker i=1, 2, . . . , S. When the maximum value is smaller than a predetermined threshold, it is assumed that the speaker i is less likely to appear in any cluster, that is, does not appear, and thus the parameters aᵢ and λᵢ of the corresponding speaker model and the parameter w_{j,i} (1≦j≦T) of the speaker co-occurrence model are deleted.

For “3) Occurrence of a cluster,” which cluster the entire session of the speech data belongs to, that is, an entropy as in the following Formula (14) is calculated for the above Formula (5).

$$\begin{matrix}[ Equation 14 ] & \\ - {\sum }_{y = 1}^{T} p ( y \vert {Ξ}^{( n )} , θ ) log p ( y \vert {Ξ}^{( n )} , θ ) & Formula ( 14 )\end{matrix}$$

When the entropy value is larger than a predetermined threshold, it is assumed that the session speech data Ξ⁽ⁿ⁾=(k⁽ⁿ⁾) is a new cluster which does not adapt to any existing cluster, and thus the number of clusters T is incremented, the parameters u_{T+1}, v_{T+1′} and w_{T+1,i} (1≦i≦S) of the speaker co-occurrence model are newly prepared to be set at proper values. At this time, it is desirable that u₁, u₂, . . . , u_{T+1} are appropriately normalized to meet u₁+u₂+ . . . +u_{T+1}=1.

For “4) Disappearance of a cluster,” the value of the parameter uⱼ of the speaker co-occurrence model is examined for each cluster j=1, 2, . . . , T. When the value is smaller than a predetermined threshold, it is assumed the cluster j is less likely to appear, that is, does not appear, and thus the parameters uⱼ, vⱼ and w_{i,i} (1≦i≦S) of the corresponding speaker co-occurrence model are deleted.

For “5) Split-up of a cluster,” an evaluation function as in the following Formula (15) is calculated for each cluster y with reference to m items of recently-input speech data Ξ^{(n-m+1)}, Ξ^{(n-m+2)}, . . . , Ξ⁽ⁿ⁾.

$$\begin{matrix}[ Equation 15 ] & \\ {\sum }_{τ , {τ}^{′} = n - m + 1}^{n} p ( y \vert {Ξ}^{( τ )} , θ ) p ( y \vert {Ξ}^{( {τ}^{′} )} , θ ) ( 1 - \frac{{\hat{w}}_{y}^{( τ )} \cdot {\hat{w}}_{y}^{( τ )}}{\vert {\hat{w}}_{y}^{( τ )} \vert \vert {\hat{w}}_{y}^{( {τ}^{′} )} \vert} ) & Formula ( 15 )\end{matrix}$$

The first term and the second term in the summation are calculated based on the above Formula (5). The third term is calculated by the vector defined by the following Formula (16).

$$\begin{matrix}[ Equation 16 ] & \\ {\hat{w}}_{y}^{( τ )} = ( \begin{matrix}{\hat{w}}_{y , 1}^{( τ )} \\ ⋮ \\ {\hat{w}}_{y , S}^{( τ )}\end{matrix} ) ( n - m + 1 \leq τ \leq n ) & Formula ( 16 )\end{matrix}$$

Each element in Formula (16) is calculated by use of the following Formula (17).

$$\begin{matrix}[ Equation 17 ] & \\ {\hat{w}}_{yz}^{( τ )} = \frac{{\sum }_{k = 1}^{{K}^{( τ )}} p ( z \vert y , {X}_{k }^{( τ )} , θ )}{{\sum }_{{z}^{′} = 1}^{{S}^{′}} {\sum }_{k = 1}^{{K}^{( τ )}} p ( {z}^{′} \vert y , {X}_{k}^{( τ )} , θ )} \\ ( n - m + 1 \leq τ \leq n ) & Formula ( 17 )\end{matrix}$$

The meaning of Formula (15) will be described below. Formula (17) expresses an appearance probability of the speaker z within Ξ^{(τ)} assuming that the τ-th speech data Ξ^{(τ)} belongs to the cluster y. Thus, Formula (16) results in the vector in which the appearance probabilities of the speakers in the cluster y are arranged.

The first term and the second term in the summation in Formula (15) take large values when the τ-th speech data Ξ^{(τ)} and the τ′-th speech data Ξ^{(τ′)} are likely to belong to the cluster y. The third term indicates a degree of difference which is obtained by inverting the sign of the cosine similarity of the vector in Formula (16) and adding 1 thereto, and thus takes a large value when the appearance probability of each speaker is different between the τ-th speech data Ξ^{(τ)} and the τ′-th speech data Ξ^{(τ′)}. From the above, Formula (15) takes a large value when the τ-th speech data Ξ^{(τ)} and the Tτ′-th speech data Ξ^{(τ′)} belong to the same cluster and the appearance probability of the speaker is different therebetween for the m items of recently-input speech data.

Thus, the cluster y for which the value of Formula (15) is maximum and exceeds a predetermined threshold is considered as being split up, and the cluster is divided.

For a specific division operation, for example, when the cluster y is to be divided into two clusters y1 and y2, a well-known clustering technique such as K-means is used to divide the vector (τ=n−m+1, n−m+2, . . . , n) in Formula (16) into two groups, and the average vectors of the respective groups may be assigned to the parameters w_{y1,z} and w_{y2,z} of the speaker co-occurrence model. For the parameter u_{y}, ½ of the average vector may be assigned to u_{y1} and u_{y2}, and for the parameter v_{y}, the same value may be copied to v_{y1} and v_{y2}.

For “6) Merger of clusters,” the vector w_{y} expressed in the following Formula (18) is configured of the parameter w_{yz} of the speaker co-occurrence model to calculate the inner product w_{y}·w_{y′} of the vectors between clusters. When the value of the inner product is large, the similarity between the appearance probabilities of the speakers is high and it is assumed that the appearance probability of the speaker is similar between the clusters y and y′, so that the clusters y and y′ are merged.

$$\begin{matrix}[ Equation 18 ] & \\ {w}_{y} = ( \begin{matrix}{w}_{y , 1} \\ ⋮ \\ {w}_{y , S}\end{matrix} ) & Formula ( 18 )\end{matrix}$$

For a specific merger operation, for example, for the parameters w_{yz} and v_{y}, the values of the parameters in both clusters are added and divided by 2, that is, an average thereof may be taken. For the parameter u_{y}, a sum of both clusters may be u_{y}+u_{y′} may be taken.

When the model structure update means 409 updates the structure of the speaker model or the speaker co-occurrence model due to occurrence or disappearance of a speaker, or occurrence, disappearance, split-up or merger of clusters, the speaker model learning means 402, the speaker classification means 403 and the speaker co-occurrence learning means 404 desirably perform the operations in steps S41 to S45 and re-learn each model.

As a result of the re-learning, whether to finally update the structure of each model is examined by a well-known model selection criterion such as minimum description length (MDL) criterion, Akaike's information criterion (AIC) or Bayesian information criterion (BIC), and when it is determined that the update of the model is unnecessary, the model before the update is desirably maintained.

It is assumed that the calculations of Formula (5), Formula (10), Formula (11) and Formula (12) in the above steps are made by use of all the items of speech data recorded in the session speech data storage means 400 each time, but this can cause an enormous amount of calculations. In such a case, if the calculations are made with reference to only the latest speech data or m items of latest speech data with the method described in the document “M. Neal et al., “A View of the EM Algorithm That Justifies Incremental, Sparse, and Other Variants,” Learning in Graphical Models, The MIT Press, November 1998, p. 355-368” (Non-Patent Literature 2), the amount of calculation can be reduced.

The recognition means 42 recognizes a speaker included in any given speech data through the operations of the session matching means 407, the speaker model storage means 404 and the speaker co-occurrence model storage means 406. The details of the operations are the same as those in the first or second embodiment and thus the explanation thereof will be omitted.

As described above, in addition to the effects of the first or second embodiment, the present embodiment is configured such that in the learning means 41, the data input means 408 receives newly-obtained speech data and adds it to the session speech data storage means 400 and the model structure update means 409 detects the events such as occurrence of a speaker, disappearance of a speaker, occurrence of a cluster, disappearance of a cluster, split-up of a cluster and merger of clusters according to the added speech data, thereby to update the structures of the speaker model and the speaker co-occurrence model, and thus, even when a speakers or a co-occurrence relationship between the speakers changes over time, the change is followed thereby to recognize the speakers with high accuracy. Since the learning means 41 is configured to detect the events, a behavior pattern of a speaker or a cluster (a collection of speakers) can be known, and information effective for making pursuit of the criminals of bank transfer scam or terrorist crimes can be extracted from a large amount of speech data and provided.

### Fourth Embodiment

A fourth embodiment according to the present invention will be described below. FIG. 11 is a block diagram showing an exemplary structure of a speech data analysis device according to the fourth embodiment of the present invention. As shown in FIG. 11, the speech data analysis device according to the present embodiment comprises a learning means 51 and a recognition means 52.

The learning means 51 includes a session speech data storage means 500, a session speaker label storage means 501, a speaker model learning means 502, a speaker classification means 503, a speaker co-occurrence learning means 504, a speaker model storage means 505 and a speaker co-occurrence model storage means 506. The recognition means 52 includes a session matching means 507, the speaker model storage means 505 and the speaker co-occurrence model storage means 506. The recognition means 52 and the learning means 51 share the speaker model storage means 504 and the speaker co-occurrence model storage means 506 with each other.

The means schematically operate as follows.

The learning means 51 learns a speaker model and a speaker co-occurrence model through the operations of the session speech data storage means 500, the session speaker label storage means 501, the speaker model learning means 502, the speaker classification means 503, the speaker co-occurrence learning means 504, the speaker model storage means 505 and the speaker co-occurrence model storage means 506. The details of the respective operations are the same as those of the session speech data storage means 300, the session speaker label storage means 301, the speaker model learning means 302, the speaker classification means 303, the speaker co-occurrence learning means 304, the speaker model storage means 305 and the speaker co-occurrence model storage means 306 according to the second embodiment and thus the explanation thereof will be omitted.

The structure of the learning means 51 may be the same as the structure of the learning means 11 according to the first embodiment or the learning means 41 according to the third embodiment.

The recognition means 52 recognizes a cluster to which any given speech data belongs through the operations of the session matching means 507, the speaker model storage means 504 and the speaker co-occurrence model storage means 506.

The session matching means 507 receives arbitrary session speech data Ξ. The speech data includes a form in which only a single speaker speaks or a utterance sequence form in which multiple speakers speak in turns as described above.

The session matching means 507 further estimates which cluster the speech data Ξ belongs to, with reference to the speaker model and the speaker co-occurrence model which are previously calculated by the learning means 51 and are recorded in the speaker model storage means 504 and the speaker co-occurrence model storage means 506, respectively. Specifically, a probability that the speech data Ξ belongs is calculated per cluster based on the above Formula (5).

Thus, y at which the probability p(y|Ξ, θ) is maximum is found so that the cluster to which the speech data belongs can be calculated. Since the denominator in the right-hand side in Formula (5) is a constant not dependent on y, the calculation can be omitted. A total sum of the speakers i in the numerator may be replaced with the maximum value operation maxᵢ for approximate calculation as is often made in this kind of calculations.

In the above operations, it is assumed that the speech data input into the recognition means 52 belongs to any one cluster learned by the learning means 51. However, the speech data belonging to an unknown cluster, which has not been obtained by the learning stage, may be input for actual applications. In such a case, there may be introduced a processing of, during the acquisition of the maximum value of the probability p(y|Ξ, θ), when the maximum value is equal to or less than a threshold, determining that the speech data belongs to an unknown cluster. Alternatively, a threshold determination may be made on the criterion such as the entropy of Formula (14).

As described above, according to the present embodiment, the session matching means 507 in the recognition means 52 is configured to estimate the ID of the cluster (set of speakers) to which the input speech data belongs, and thus a set of speakers can be recognized in addition to individual speakers. That is, a criminal group can be recognized, not individual bank transfer scam criminals or terrorists. Further, arbitrary speech data can be automatically classified based on a similarity between relevant persons' structures (casting).

### Fifth Embodiment

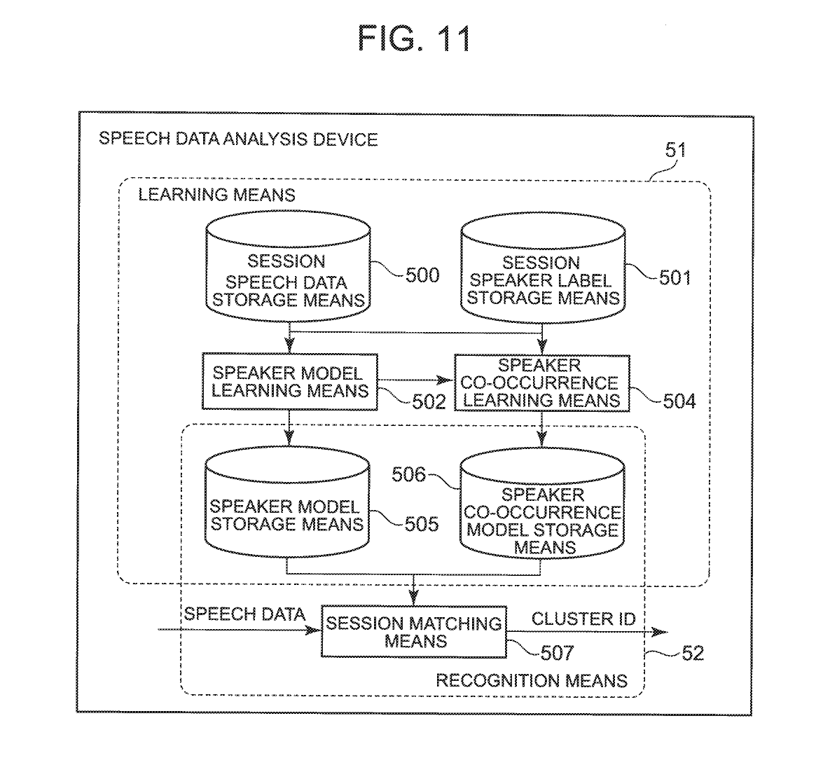

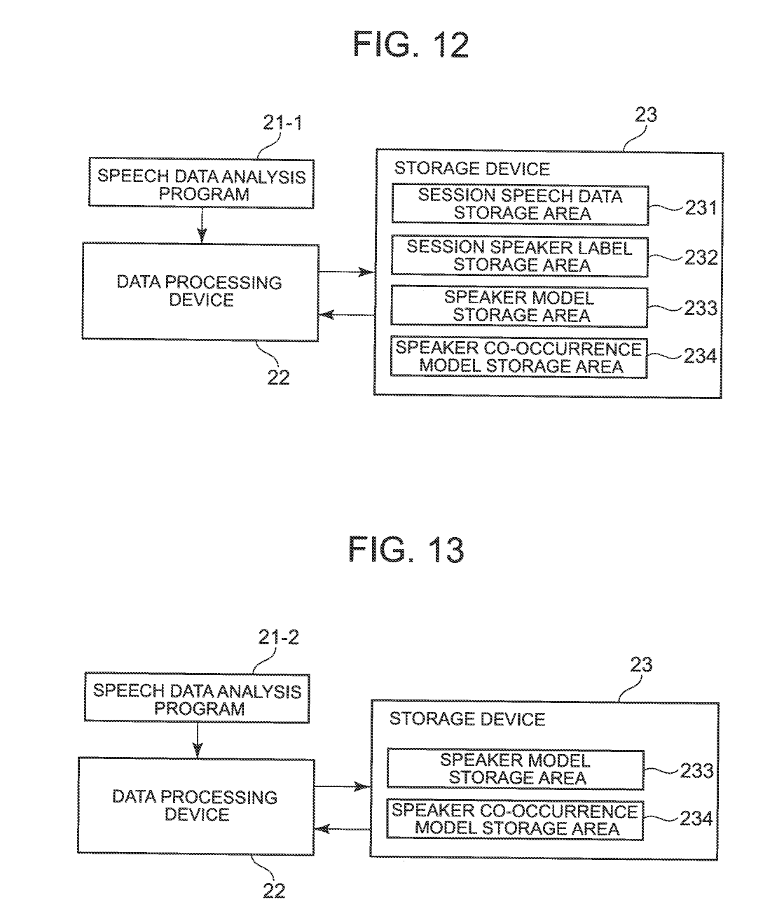

A fifth embodiment according to the present invention will be described below. FIG. 12 is a block diagram showing an exemplary structure of a speech data analysis device (model generation device) according to the fifth embodiment of the present invention. As shown in FIG. 12, the speech data analysis device according to the present embodiment comprises a speech data analysis program 21-1, a data processing device 22 and a storage device 23. The storage device 23 includes a session speech data storage area 231, a session speaker label storage area 232, a speaker model storage area 233 and a speaker co-occurrence model storage area 234. The present embodiment is an exemplary structure in which the learning means 11 according to the first embodiment is implemented by a computer operating according to programs.

The speech data analysis program 21-1 is read by the data processing device 22 to control the operations of the data processing device 22. The speech data analysis program 21-1 describes therein the operations of the learning means according to the first embodiment in a program language. Not only the learning means 11 according to the first embodiment but also the learning means (the learning means 31, the learning means 41 and the learning means 51) according to the second to fourth embodiments can be implemented by a computer operating according to programs. In such a case, the speech data analysis program 21-1 may describe therein the operations of any learning means according to the first to fourth embodiments in a program language.

That is, the data processing device 22 performs the same processing as the processing by the speaker model learning means 102 and the speaker co-occurrence learning means 104 according to the first embodiment, the processing by the speaker model learning means 302, the speaker classification means 303 and the speaker co-occurrence learning means 304 according to the second embodiment, the processing by the data input means 408, the speaker model learning means 402, the speaker classification means 403, the speaker co-occurrence learning means 404 and the model structure update means 409 according to the third embodiment or the processing by the speaker model learning means 502, the speaker classification means 503 and the speaker co-occurrence learning means 504 according to the fourth embodiment under control of the speech data analysis program 21-1.

The data processing device 22 performs the processing according to a speech data analysis program 51-1, and thereby reads the speech data and the speaker label recorded in the session speech data storage area 231 and the session speaker label storage area 232 in the storage device 23, respectively, uses the same to find a speaker model and a speaker co-occurrence model, and records the found speaker model and speaker co-occurrence model in the speaker model storage area 233 and the speaker co-occurrence model storage area 234 in the storage device 23, respectively.

As described above, with the speech data analysis device (model generation device) according to the present embodiment, the speaker model and the speaker co-occurrence model effective for learning or recognizing a speaker from the speech data spoken by multiple speakers can be obtained and thus the obtained speaker model and speaker co-occurrence model are used thereby to recognize the speakers with high accuracy.

### Sixth Embodiment

A sixth embodiment according to the present invention will be described below. FIG. 13 is a block diagram showing an exemplary structure of a speech data analysis device (speaker recognition device) according to the sixth embodiment of the present invention. As shown in FIG. 13, the speech data analysis device according to the present embodiment comprises a speech data analysis program 21-2, the data processing device 22 and the storage device 23. The storage device 23 includes the speaker model storage area 233 and the speaker co-occurrence model storage area 234. The present embodiment is an exemplary structure in which the recognition means according to the first embodiment is implemented by a computer operating according to programs.

The speech data analysis program 21-2 is read in the data processing device 22 to control the operations of the data processing device 22. The speech data analysis program 21-2 describes therein the operations of the recognition means 12 according to the first embodiment in a program language. Not only the recognition means 12 according to the first embodiment but also the recognition means (the recognition means 32, the learning means 42 or the learning means 52) according to the second to fourth embodiments may be implemented by a computer operating according to programs. In such a case, the speech data analysis program 21-2 may describe therein the operations of any recognition means according to the first to fourth embodiments in a program language.

That is, the data processing device 22 performs the same processing as the processing by the session matching means 107 according to the first embodiment, the processing by the session matching means 307 according to the second embodiment, the processing by the session matching means 407 according to the third embodiment or the processing by the session matching means 507 according to the fourth embodiment under control of the speech data analysis program 21-2.

The data processing device 22 performs the processing according to the speech data analysis program 21-2 thereby to recognize a speaker or a set of speakers for any speech data with reference to the speaker model and the speaker co-occurrence model recorded in the speaker model storage area 233 and the speaker co-occurrence model storage area 234 in the storage device 23, respectively. It is assumed that the speaker model storage area 233 and the speaker co-occurrence model storage area 234 previously store therein the speaker model and the speaker co-occurrence model similar to those generated under control of the learning means in the present embodiment or the data processing device 52 by the speech data analysis program 51-1.

As described above, with the speech data analysis device (speaker/set of speakers recognition device) according to the present embodiment, speakers are recognized in consideration of a co-occurrence consistency between the speakers in the entire session by use of the speaker model and the speaker co-occurrence model as a modeled (expressed as a formula and the like) co-occurrence relationship between the speakers, thereby recognizing the speakers with high accuracy. Further, a set of speakers can be recognized in addition to individual speakers. The present embodiment has the same effects as those in the first to fourth embodiments except for that the speaker model and the speaker co-occurrence model are previously stored and thus the modeling operation processing can be omitted. When the recognition means according to the third embodiment is to be implemented, there may be configured such that the contents of the storage device 23 are updated whenever the speaker model and the speaker co-occurrence model are updated by the learning means implemented by another device, for example.

The speech data analysis program 51 combining the speech data analysis program 51-1 according to the fifth embodiment and the speech data analysis program 51-2 according to the sixth embodiment therein is read in the data processing device 52 thereby to cause the data processing device 52 to perform the respective processing of the learning means and the recognition means according to the first to fourth embodiments.

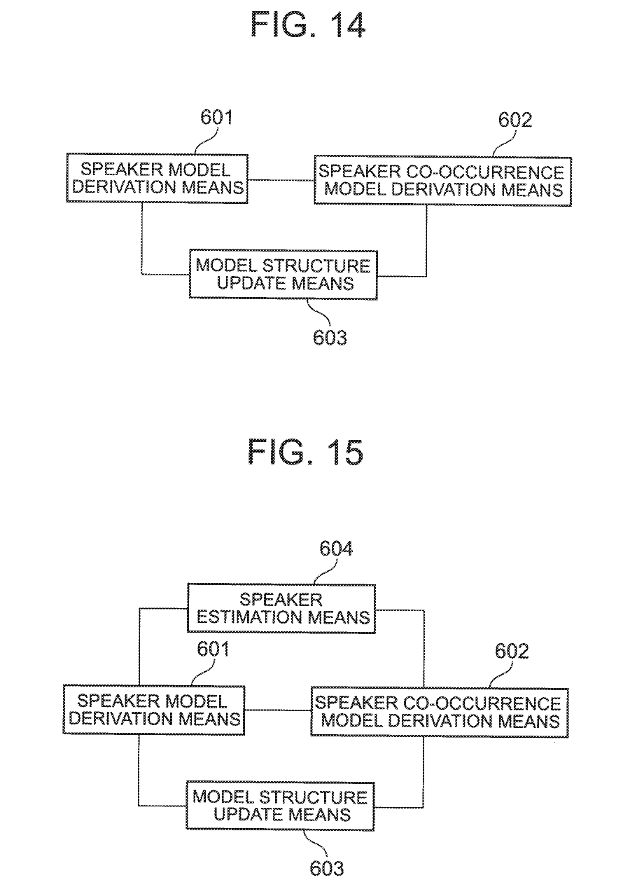

The outline of the present invention will be described below. FIG. 14 is a block diagram showing the outline of the present invention. A speech data analysis device shown in FIG. 14 comprises a speaker model derivation means 601, a speaker co-occurrence model derivation means 602 and a model structure update means 603.

The speaker model derivation means 601 (such as the speaker model learning means 102, 302, 402 or 502) derives a speaker model defining a voice property per speaker from speech data made of multiple utterances. It is assumed that a speaker label for identifying a speaker of a utterance contained in speech data is given to at least part of the speech data.

The speaker model derivation means 601 may derive a probability model defining an appearance probability of a voice characteristic amount per speaker, as a speaker model, for example. The probability model may be a Gaussian mixed model or hidden Markov model, for example.

The speaker co-occurrence model learning means 602 (such as the speaker co-occurrence model learning means 104, 304, 404 or 504) uses the speaker model derived by the speaker model learning means 601 to derive a speaker co-occurrence model indicating a strength of a co-occurrence relationship between speakers from session data which is divided speech data in units of a series of conversation.

The speaker co-occurrence model learning means 602 may derive a Markov network which is defined by an appearance probability of a set of speakers in a strong co-occurrence relationship or a cluster and an appearance probability of a speaker in the cluster, as a speaker co-occurrence model, for example.

The speaker model derivation means 601 and the speaker co-occurrence model learning means 602 may make iterative operations on and learn the speaker model and the speaker co-occurrence model based on any criterion such as likelihood maximization criterion, maximum a posterior probability criterion or Bayesian criterion for the speaker label given to the speech data or the utterance contained in the speech data.

The model structure update means 603 (such as the model structure update means 409) detects predefined events in which a speaker or a cluster as a set of speakers changes in a speaker model or a speaker co-occurrence model, with reference to a session of newly-added speech data, and when a predetermined event is detected, updates a structure of at least one of the speaker model and the speaker co-occurrence model.

Occurrence of a speaker, disappearance of a speaker, occurrence of a cluster, disappearance of a cluster, split-up of a cluster or merger of clusters may be defined as the events in which a speaker or a cluster as a set of speakers changes.

For example, when occurrence of a speaker is defined as an event in which a speaker or a cluster as a set of speakers changes, the model structure update means 603 may detect an occurrence of a speaker and may add a parameter defining a new speaker to the speaker model when an entropy of an estimation result of a speaker label as information for identifying a speaker given to a utterance is larger than a predetermined threshold for each utterance in a session of newly-added speech data.

For example, when disappearance of a speaker is defined as an event in which a speaker or a cluster as a set of speakers changes, the model structure update means 603 may detect a disappearance of a speaker and may delete parameters defining the speakers in the speaker model when the values of all the parameters corresponding to appearance probabilities of speakers in a speaker co-occurrence model is smaller than a predetermined threshold.

For example, when occurrence of a cluster is defined as an event in which a speaker or a cluster as a set of speakers changes, the model structure update means 603 may detect an occurrence of a cluster and may add a parameter defining a new cluster to the speaker co-occurrence model when an entropy of a probability that a session belong to each cluster is larger than a predetermined threshold for the session of newly-added speech data.

For example, when disappearance of a cluster is defined as an event in which a speaker or a cluster as a set of speakers changes, the model structure update means 603 may detect a disappearance of a cluster and may delete a parameter defining the cluster in the speaker co-occurrence model when a parameter value corresponding to an appearance probability of a cluster in a speaker co-occurrence model is smaller than a predetermined threshold.

For example, when split-up of a cluster is defined as an event in which a speaker or a cluster as a set of speakers changes, the model structure update means 603 may calculate a probability that sessions belong to each cluster and appearance probabilities of the speakers for the sessions of a predetermined number of items of recently-added speech data, calculate a probability that session pairs belong to the same cluster and a degree of difference the appearance probabilities of the speakers for respective the session pairs, detect a split-up of a cluster and divide the parameters defining the cluster in the speaker co-occurrence model when an evaluation function defined by the probability that the session pairs belong to the same cluster and the degree of difference is larger than a predetermined threshold.

For example, when merger of clusters is defined as an event in which a speaker or a cluster as a set of speakers changes, the model structure update means 603 may compare the appearance probabilities of speakers in a speaker co-occurrence model between clusters, detect a merger of clusters and integrate the parameters defining the cluster pair in the speaker co-occurrence model when there is a cluster having a higher similarity between the appearance probabilities of the speakers than a predetermined threshold.

The model structure update means 603 may determine whether to update the structure of the speaker model or the speaker co-occurrence model, based on a model selection criterion such as minimum description length (MDL) criterion, Akaike's information criterion (AIC) or Bayesian information criterion (BIC).

FIG. 14 is a block diagram showing another exemplary structure of the speech data analysis device according to the present invention. As shown in FIG. 14, the speech data analysis device may further comprise a speaker estimation means 604.

When the speaker of the utterance contained in the speech data input in the speaker model derivation means 601 or the speaker co-occurrence model derivation means 602 is unknown or when a utterance not given with a speaker label is present in the speech data, the speaker estimation means 604 (such as the speaker classification means 304 or 404) estimates a speaker label of the utterance not given with a speaker label with reference to the speaker model or speaker co-occurrence model derived at least at that time.

In such a case, the speaker model derivation means 601, the speaker co-occurrence model derivation means 602 and the speaker estimation means 604 may repeatedly operate in turns.

FIG. 15 is a block diagram showing another exemplary structure of the speech data analysis device according to the present invention. As shown in FIG. 15, the speech data analysis device may comprise a speaker model storage means 605, a speaker co-occurrence model storage means 606 and a speaker set recognition means 607.

The speaker model storage means 605 (such as the speaker model storage means 105, 305, 405 or 505) stores a speaker model defining a voice property per speaker, which is derived from speech data made of multiple utterances.

The speaker co-occurrence model storage means 605 (such as the speaker co-occurrence model storage means 106, 306, 406 or 506) stores a speaker co-occurrence model indicating a strength of a co-occurrence relationship between speakers, which is derived from session data which is divided speech data in units of a series of conversation.

The speaker set recognition means 607 (such as the session matching means 507) uses the stored speaker model and speaker co-occurrence model to calculate a consistency with the speaker model and a consistency of a co-occurrence relationship in entire speech data for each utterance contained in the designated speech data, thereby recognizing which cluster the designated speech data corresponds to.

The speaker set recognition means 607 may calculate a probability that a session of designated speech data corresponds to each cluster, and select a cluster for which the calculated probability is maximum as a recognition result, for example. For example, when the probability of the cluster for which the calculated probability is maximum does not reach a predetermined threshold, it may be determined that there is no corresponding cluster.

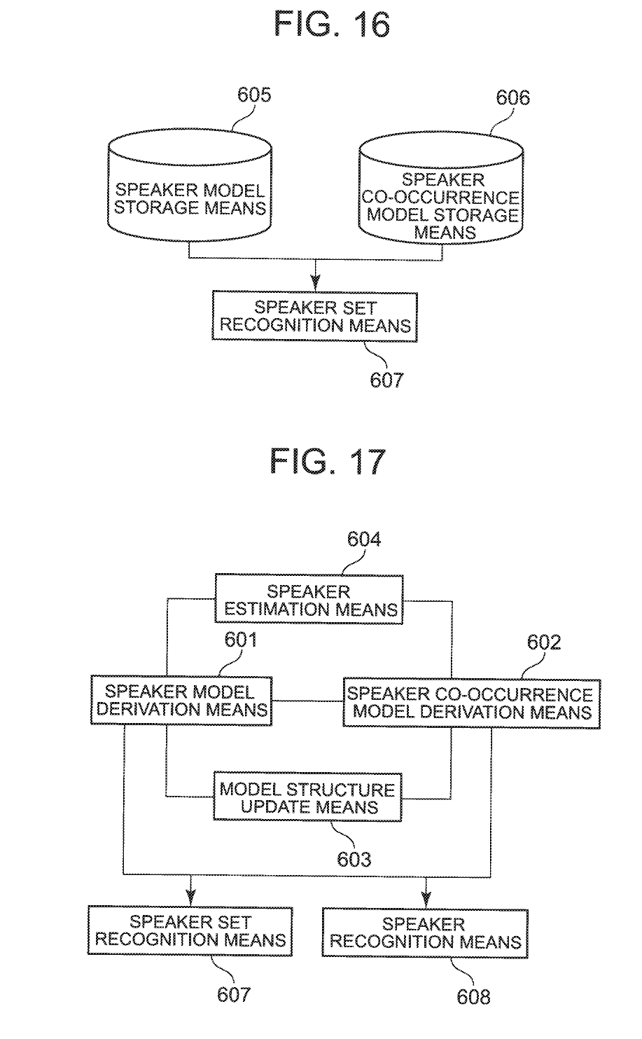

As shown in FIG. 16, the speaker model derivation means 601, the speaker co-occurrence model derivation means 602, the model structure update means 603, and as needed, the speaker estimation means 604 are provided instead of the storage means, and the operations from generation and update of a model to recognition of a set of speakers may be implemented by one device. The speaker recognition means 608 for recognizing of which speaker each utterance contained in designated speech data is, instead of the speaker set recognition means 607 or together with the speaker set recognition means 607 may be provided.

The speaker recognition means 608 (such as the session matching means 107, 307 or 407) uses the speaker model and the speaker co-occurrence model to calculate a consistency with the speaker model and a consistency of a co-occurrence relationship in entire speech data for each utterance contained in the designated speech data, thereby recognizing of which speaker each utterance contained in the designated speech data is. As in the fourth embodiment, the speaker set recognition means 607 and the speaker set recognition means 608 may be mounted as one speaker/a set of speakers recognition means.

The present invention has been described with reference to the embodiments and the examples, but the present invention is not limited to the embodiments and the example. The structure and details of the present invention may be variously modified to be understood by those skilled in the art within the scope of the present invention.

The present application claims the priority based on Japanese Patent Application 2009-267770 filed on Nov. 25, 2009, the disclosure of which is all incorporated herein.

### INDUSTRIAL APPLICABILITY

The present invention is applicable to a speaker search device or speaker collation device for collating a person database recording many persons' voices therein, and an input voice. Further, it is applicable to an indexing/search device for media data such as videos and voices, or a conference record creation support device or a conference support device for recording utterances of persons attending in a conference. Further, it is suitably applicable to recognition of speakers of speech data or recognition of a set of speakers along with a temporal change in a relationship between the speakers.

### REFERENCE SIGNS LIST

11, 31, 41, 51: Learning means
100, 300, 400, 500: Session speech data storage means
101, 301, 401, 501: Session speaker label storage means
102, 302, 402, 502: Speaker model learning means
104, 304, 404, 504: Speaker co-occurrence learning means
105, 305, 405, 505: Speaker model storage means
106, 306, 406, 506: Speaker co-occurrence model storage means
303: Speaker classification means
408: Data input means
409: Model structure update means
12, 32, 42, 52: Recognition means
107, 307, 407, 507: Session matching means
21, 21-1, 21-2: Voice data analysis program
22: Data processing device
23: Storage device
231: Session speech data storage area
232: Session speaker label storage area
233: Speaker model storage area
234: Speaker co-occurrence model storage area
601: Speaker model derivation means
602: Speaker co-occurrence model derivation means
603: Model structure update means
604: Speaker estimation means
605: Speaker model storage means
606: Speaker co-occurrence model storage means
607: Speaker set recognition means
608: Speaker recognition means

1.-10. (canceled)

11. A speech data analysis device comprising:
speaker model derivation unit which derives a speaker model defining a voice property per speaker from speech data made of multiple utterances;
speaker co-occurrence model derivation unit which, by use of the speaker model derived by the speaker model derivation unit, derives a speaker co-occurrence model indicating a strength of a co-occurrence relationship between the speakers from session data which is divided the speech data in units of a series of conversation; and
model structure update unit which, with reference to a session of newly-added speech data, detects predefined events in which a speaker or a cluster as set of speakers changes in the speaker model or the speaker co-occurrence model, and when the event is detected, updates a structure of at least one of the speaker model and the speaker co-occurrence model.

12. The speech data analysis device according to claim 11, wherein occurrence of a speaker, disappearance of a speaker, occurrence of a cluster, disappearance of a cluster, split-up of a cluster or merger of clusters is defined as events in which a speaker or a cluster as a set of speakers changes.

13. The speech data analysis device according to claim 11, wherein at least occurrence of a speaker or disappearance of a speaker is defined as events in which a speaker or a cluster as a set of speakers changes,
when occurrence of a speaker is defined as an event in which a speaker or a cluster as a set of speakers changes, the model structure update unit detects an occurrence of a speaker and adds a parameter defining a new speaker to a speaker model when an entropy of an estimation result of a speaker label as information for identifying a speaker given to the utterance is larger than a predetermined threshold for each utterance in a session of newly-added speech data, and
when disappearance of a speaker is defined as an event in which a speaker or a cluster as a set of speakers changes, the model structure update unit detects a disappearance of a speaker and deletes parameters defining the speakers in the speaker model when the values of all the parameters corresponding to appearance probabilities of speakers in a speaker co-occurrence model are smaller than a predetermined threshold.

14. The speech data analysis device according to claim 11, wherein at least any one of occurrence of a cluster, disappearance of a cluster, split-up of a cluster and merger of clusters is defined as an event in which a speaker or a cluster as a set of speakers changes,
when occurrence of a clusters is defined as an event in which a speaker or a cluster as a set of speakers changes, the model structure update unit detects an occurrence of a cluster and adds a parameter defining a new cluster to a speaker co-occurrence model when an entropy of a probability that a session belong to each cluster is larger than a predetermined threshold for the session of newly-added speech data,
when disappearance of a cluster is defined as an event in which a speaker or a cluster as set of speakers changes, the model structure update unit detects a disappearance of a cluster and deletes a parameter defining the cluster in the speaker co-occurrence model when a value of a parameter corresponding to an appearance probability of the cluster in a speaker co-occurrence model is smaller than a predetermined threshold,
when split-up of a cluster is defined as an event in which a speaker or a cluster as set of speakers changes, the model structure update unit calculates a probability that a session belong to each cluster and appearance probabilities of the speakers for the session of a predetermined number of items of recently-added speech data, calculates a probability that cluster pairs belong to the same cluster and a degree of difference of the appearance probabilities of the speakers for respective the cluster pairs, detects a split-up of the cluster and divides parameters defining the cluster in the speaker co-occurrence model when an evaluation function defined by the probability that the cluster pairs belong to the same cluster and the degree of difference is larger than a predetermined threshold, and
when merger of clusters is defined as an event in which a speaker or a cluster as a set of speakers changes, the model structure update unit compares the appearance probabilities of the speakers in a speaker co-occurrence model between clusters, detects a merger of the clusters and integrates parameters defining a cluster pair of the speaker co-occurrence model when there is present the cluster having a similarity between the appearance probabilities of the speakers higher than a predetermined threshold.

15. The speech data analysis device according to claim 11, comprising:
speaker estimation unit which, when a speaker of each utterance contained in speech data is unknown, estimates a speaker of each utterance with reference to a speaker model and a speaker co-occurrence model.

16. A speech data analysis device comprising:
speaker model storage unit which stores a speaker model defining a voice property per speaker which is derived from speech data made of multiple utterances;
speaker co-occurrence model storage unit which stores a speaker co-occurrence model indicating a strength of a co-occurrence relationship between the speakers which is derived from session data which is divided speech data in units of a series of conversation; and
speaker set recognition unit which, by use of the speaker model and the speaker co-occurrence model, calculates a consistency with the speaker model and a consistency with a co-occurrence relationship in entire speech data for each utterance contained in the designated speech data, and recognizes which cluster the designated speech data corresponds to.

17. A speech data analysis method comprising:
deriving a speaker model defining a voice property per speaker from speech data made of multiple utterances;
deriving a speaker co-occurrence model indicating a strength of a co-occurrence relationship between the speakers from session data which is divided speech data in units of a series of conversation by use of the derived speaker model; and
with reference to a session of newly-added speech data, detecting predefined events in which a speaker or a cluster as a set of speakers changes in the speaker model or the speaker co-occurrence model, and when the event is detected, updating a structure of at least one of the speaker model and the speaker co-occurrence model.
